(19) United States
(12) Patent Application Publication
(10) Pub. No.: US 2008/0182917 A1
(43) Pub. Date: Jul. 31, 2008

(54) Production method of encapsulated material, and encapsulated material

(75) Inventor: Toshiyuki Miyabayashi, Shiojiri-shi (JP)

Correspondence Address: LADAS & PARRY LLP, 26 WEST 61ST STREET, NEW YORK, NY, 10023, US

(73) Assignee: SEIKO EPSON CORPORATION

(21) Appl. No.: 12/011,013

(22) Filed: Jan. 23, 2008

(30) Foreign Application Priority Data
Jan. 24, 2007 (JP) 2007-013442

(51) Int. Cl. C08J 3/28; C08J 5/00

(52) U.S. Cl. 522/71; 524/700

(57) ABSTRACT

A method for producing an encapsulated material in which a core substance having an electric charge on its surface is coated with a wall material mainly comprising a polymer, wherein the wall material polymer is formed by a specific process.

### FIELD OF THE INVENTION

The present invention relates to a production method of an encapsulated material enclosing an inorganic or organic substance, particularly an encapsulated material on the nano order for enclosing such a substance. More specifically, the present invention relate to a production method of an encapsulated material useful, for example, as an additive in an ink, a coating material or the like.

### BACKGROUND OF THE INVENTION

Conventionally, encapsulation of various substances has been performed in many industrial and technical fields. In the industry of printing, coating material and ink, a large number of encapsulation techniques using a pigment, a coloring matter or the like as the core substance have been practiced. Also, in the medical or agricultural field, many attempts have been made to encapsulate a drug as the core substance for the purpose of, for example, increasing the efficacy, decreasing the toxicity, imparting the stability, or sustaining the effect. As for the encapsulation method, there are known a phase separation method (coacervation method), an in-liquid drying method (interfacial precipitation method), a spray drying method, a pan coating method, an in-liquid curing coating method, an interfacial polymerization method, an interfacial inorganic reaction method, an in-situ polymerization method and the like. However, these methods have a problem, for example, the core substance is limited, the thickness of the shell layer (wall material) coating the core substance is hard to freely design, encapsulation of one core substance is difficult, the functional group on the capsule surface is hard to freely design, a particle having a uniform surface state cannot be easily produced, encapsulation on the nano order is not easy, application to a relatively unstable compound is difficult, a solvent used at the production of a preparation is readily mixed into the product, or the property of the obtained capsule is not satisfied. Also, the resulting encapsulated material itself has a problem depending on the usage.

In an inkjet recording method of jetting out an ink droplet from a fine nozzle head and recording a character or a figure on the surface of a recording medium such as paper, an aqueous pigment ink obtained by dispersing a pigment in water has recently put into use because of its excellent water resistance or light fastness. As for such an aqueous pigment ink, those obtained by dispersing a pigment in an aqueous dispersion medium with use of a dispersant such as surfactant or polymer dispersant are generally used in many cases. However, when a dispersant is used for dispersing pigment particles, the ink composition has many points to be adjusted for ensuring preferred properties as an ink, for example, there is a problem that when high printing density, fixing property or scratch resistance is intended to attain, the viscosity tends to become high.

Furthermore, in such an aqueous pigment ink obtained by dispersing pigment particles with use of a dispersant, the dispersant merely adsorbs to the pigment particle surface and in the inkjet recording method where a strong shear force is applied to the pigment particle when the ink is jetted out through a fine nozzle of a nozzle head, the dispersant adsorbing to the pigment particle surface may be desorbed, thereby decreasing the dispersibility of pigment particles and worsening the ejection stability (the property that the ink is stably jetted out to a constant direction from a recording head). Also, in an aqueous pigment ink obtained by dispersing pigment particles with use of a dispersant, desorption or absorption of the dispersant is liable to occur and when the ink is stored for a long time, the dispersion of pigment particles readily becomes unstable.

On the other hand, as regards a particle dispersion-type inkjet ink like the above-described aqueous pigment ink, there is known a technique of using an encapsulated material obtained by coating a dispersed particle with a polymer, for the purpose of enhancing the fixing property of the dispersed particle (for example, pigment particle) contained in the ink on a recording medium. For example, those obtained by encapsulating a pigment particle (see, for example, Patent Documents 1, 2 and 3) or obtained by graft-polymerizing a polymer to the surface of a pigment particle (see, for example, Patent Documents 4 to 7) have been proposed as the encapsulated material. Also, in Patent Document 8, a method of encapsulating a hydrophobic powder particle by using an amphipathic graft polymer has been proposed, but this method has a problem that when a previously polymerized polymer is used for the encapsulation, the particle-size after encapsulation becomes excessively large.

As regards the encapsulated material, other than these proposals, there have been proposed an ink using a pigment on which a resin capable of forming a film at room temperature is coated by a phase inversion emulsification method (see, for example, Patent Documents 9 to 17), an ink using a pigment on which an anionic group-containing organic polymer compound is coated by an acid precipitation method (see, for example, Patent Documents 18 to 27), and an ink using a polymer emulsion impregnated with a polymer fine particle and a color material by a phase inversion emulsification method (see, for example, Patent Documents 28 to 33). However, when a color material (pigment particle) obtained by the phase inversion emulsification method or acid precipitation method is used for the ink, the polymer adsorbed to the color material is sometimes desorbed and dissolves in the ink depending on the kind of the organic solvent such as penetrant, and this gives rise to a problem that, for example, the dispersion stability or ejection stability of ink or the image quality is insufficient. Also, in the phase inversion emulsification method, due to remaining of the organic solvent used in the production process, for example, the dispersion stability or ejection stability of ink or the image quality may fluctuate, or erosion or the like of the plastic member of a printer may be caused.

| | |
|---|---|
| Patent Document 1: | JP-B-7-94634 |
| Patent Document 2: | JP-A-8-59715 |
| Patent Document 3: | JP-A-2003-306661 |
| Patent Document 4: | JP-A-5-339516 |
| Patent Document 5: | JP-A-8-302227 |
| Patent Document 6: | JP-A-8-302228 |
| Patent Document 7: | JP-A-8-81647 |
| Patent Document 8: | JP-A-5-320276 |
| Patent Document 9: | JP-A-8-218015 |
| Patent Document 10: | JP-A-8-295837 |
| Patent Document 11: | JP-A-9-3376 |
| Patent Document 12: | JP-A-8-183920 |
| Patent Document 13: | JP-A-10-46075 |
| Patent Document 14: | JP-A-10-292143 |
| Patent Document 15: | JP-A-11-80633 |
| Patent Document 16: | JP-A-11-349870 |
| Patent Document 17: | JP-A-2000-7961 |
| Patent Document 18: | JP-A-9-31360 |
| Patent Document 19: | JP-A-9-217019 |
| Patent Document 20: | JP-A-9-316353 |
| Patent Document 21: | JP-A-9-104834 |
| Patent Document 22: | JP-A-9-151342 |
| Patent Document 23: | JP-A-10-140065 |
| Patent Document 24: | JP-A-11-152424 |
| Patent Document 25: | JP-A-11-166145 |
| Patent Document 26: | JP-A-11-199783 |
| Patent Document 27: | JP-A-11-209672 |
| Patent Document 28: | JP-A-9-286939 |
| Patent Document 29: | JP-A-2000-44852 |
| Patent Document 30: | JP-A-2000-53897 |
| Patent Document 31: | JP-A-2000-53898 |
| Patent Document 32: | JP-A-2000-53899 |
| Patent Document 33: | JP-A-2000-53900 |

### SUMMARY OF THE INVENTION

The present invention has been made by taking account of those problems, and an object of the present invention is to provide a production method of an encapsulated material, ensuring that an encapsulated material useful in various industrial and technical fields including an inkjet recording technique can be produced and the design latitude in the particle size of the encapsulated material is high, and an encapsulated material.

Other objects and effects of the invention will become apparent from the following description.

As a result of intensive studies, the present inventors have found that when an encapsulated material is obtained by coating a core substance having an electric charge on its surface with a wall material mainly comprising a polymer containing at least a repeating structural unit derived from an ionic polymerizable surfactant A and/or ionic monomer having an ionic group with an electric charge opposite the electric charge on the core substance surface, a hydrophobic group and a polymerizable group, a repeating structural unit derived from a hydrophobic monomer, and a repeating structural unit derived from an ionic polymerizable surfactant B with an electric charge the same as or opposite the electric charge on the core substance surface, the encapsulated material can exert various functions at a high level in various industrial and technical fields including an inkjet recording technique. Also, as a result of further studies, it has been found that in the production process of this encapsulated material, when the amount added of the ionic polymerizable surfactant B is set such that the concentration of the ionic polymerizable surfactant B in the reaction mixed solution immediately before the addition of a polymerization initiator (the reaction mixed solution containing at least the core substance, the ionic polymerizable surfactant A and/or ionic monomer, the hydrophobic monomer, the ionic polymerizable polymerization Surfactant B, and water) becomes equal to the critical micell concentration of the ionic polymerizable surfactant B for the water amount in the reaction mixed solution, an encapsulated material having a particle size proportional to the amount added of the hydrophilic monomer used for the polymerization reaction can be obtained. The present invention has been accomplished based on these findings, and its technical construction is as follows.

[1] A method for producing an encapsulated material in which a core substance having an electric charge on its surface is coated with a wall material mainly comprising a polymer, the production method comprising (1) the following steps 1, 2a, 3a and 4a or (2) the following steps 1, 2b, 3b and 4b:

step 1: a step of adding and mixing an ionic polymerizable surfactant A and/or ionic monomer containing an ionic group with an electric charge opposite the electric charge on the surface of the core substance, a hydrophobic group and a polymerizable group to an aqueous solvent containing the core substance, thereby adsorbing the ionic polymerizable surfactant A and/or ionic monomer to the surface of the core substance;

step 2a: a step of adding and mixing a hydrophobic monomer to the mixed solution passed through the step 1 above;

step 3a: a step of adding and mixing an ionic polymerizable surfactant B containing an ionic group with an electric charge the same as or opposite the electric charge on the surface of the core substance, a hydrophobic group and a polymerizable group to the mixed solution passed through the step 2a above, such that the concentration of the ionic polymerizable surfactant B in a mixed solution finally obtained in the step 3a becomes the critical micell concentration of the ionic polymerizable surfactant B for the water amount in the final mixed solution;

step 4a: a step of adding and mixing a polymerization initiator to the mixed solution passed through the step 3a above to polymerize the ionic polymerizable surfactant A and/or ionic monomer, the hydrophobic monomer and the ionic polymerizable surfactant B and thereby form the polymer;

step 2b: a step of adding and mixing an ionic polymerizable surfactant B containing an ionic group with an electric charge the same as or opposite the electric charge on the surface of the core substance, a hydrophobic group and a polymerizable group to the mixed solution passed through the step 1 above, such that the concentration of the ionic polymerizable surfactant B in a mixed solution finally obtained in the step 3b becomes the critical micell concentration of the ionic polymerizable surfactant B for the water amount in the final mixed solution;

step 3b: a step of adding and mixing a hydrophobic monomer to the mixed solution passed through the step 2b above;

step 4b: a step of adding and mixing a polymerization initiator to the mixed solution passed through the step 3b above to polymerize the ionic polymerizable surfactant A and/or ionic monomer, the ionic polymerizable surfactant B and the hydrophobic monomer and thereby form the polymer.

[2] The method for producing an encapsulated material as described in [1] above, wherein in the step 2a or 3b, a higher alcohol having a carbon number of 6 or more is further added and mixed to the mixed solution.

[3] The method for producing an encapsulated material as described in [1] or [2] above, wherein in the step 3a or 2b, a nonionic polymerizable surfactant containing a nonionic group, a hydrophobic group and a polymerizable group is further added and mixed to the mixed solution such that the concentration of the nonionic polymerizable surfactant in the final mixed solution becomes the critical micell concentration of the nonionic polymerizable surfactant for the water amount in the final mixed solution.

[4] The method for producing an encapsulated material as described in any one of [1] to [3] above, wherein in the step 1, after the ionic polymerizable surfactant A and/or ionic monomer is added and mixed to an aqueous solvent containing the core substance, an ultrasonic wave is irradiated on the aqueous solvent.

[5] The method for producing an encapsulated material as described in any one of [1] to [4] above, wherein the core substance is a color material.

[6] An encapsulated material produced by the production method described in any one of [1] to [5] above.

More specifically, this is an encapsulated material in which a core substance having an electric charge on its surface is coated with a wall material mainly comprising a polymer and the polymer contains at least a repeating structural unit derived from an ionic polymerizable surfactant A and/or ionic monomer having an ionic group with an electric charge opposite the electric charge on the core substance surface, a hydrophobic group and a polymerizable group, a repeating structural unit derived from a hydrophobic monomer, and a repeating structural unit derived from an ionic polymerizable surfactant B having an ionic group with an electric charge the same as or opposite the electric charge on the core substance surface, a hydrophobic group and a polymerizable group, the encapsulated material being produced (1) through the following steps 1, 2a, 3a and 4a or (2) through the following steps 1, 2b, 3b and 4b:

step 1: a step of adding and mixing the ionic polymerizable surfactant A and/or ionic monomer to an aqueous solvent containing the core substance, thereby adsorbing the ionic polymerizable surfactant A and/or ionic monomer to the surface of the core substance;

step 2a: a step of adding and mixing the hydrophobic monomer to the mixed solution passed through the step 1 above;

step 3a: a step of adding and mixing the ionic polymerizable surfactant B to the mixed solution passed through the step 2a above, such that the concentration of the ionic polymerizable surfactant B in a mixed solution finally obtained in the step 3a becomes the critical micell concentration of the ionic polymerizable surfactant B for the water amount in the final mixed solution;

step 4a: a step of adding and mixing a polymerization initiator to the mixed solution passed through the step 3a above to polymerize the ionic polymerizable surfactant A and/or ionic monomer, the hydrophobic monomer and the ionic polymerizable surfactant B and thereby form the polymer;

step 2b: a step of adding and mixing the ionic polymerizable surfactant B to the mixed solution passed through the step 1 above, such that the concentration of the ionic polymerizable surfactant B in a mixed solution finally obtained in the step 3b becomes the critical micell concentration of the ionic polymerizable surfactant B for the water amount in the final mixed solution;

step 3b: a step of adding and mixing the hydrophobic monomer to the mixed solution passed through the step 2b above;

step 4b: a step of adding and mixing a polymerization initiator to the mixed solution passed through the step 3b above to polymerize the ionic polymerizable surfactant A and/or ionic monomer, the ionic polymerizable surfactant B and the hydrophobic monomer and thereby form the polymer.

According to the present invention, an encapsulated material useful in various industrial and technical fields including an inkjet recording technique can be provided. Also, the design latitude in the particle size of the encapsulated material is high, so that an encapsulated material having a large particle size can be provided by increasing the film thickness of the wall material coating the core substance.

More specifically, according to the present invention, an encapsulated material satisfying all of the following (A) to (I) can be provided:

(A) the core substance is not limited, that is, in the present invention, an inorganic particle, an organic particle, a polymer particle or the like can be used as the core substance, and the core substance may be either an inorganic material or an organic material;

(B) high design latitude is allowed in the thickness of the wall material (coat layer of the core substance);

(C) one piece of the core substance can be encapsulated;

(D) the functions of core substance and wall material can be separated therebetween, accordingly, high design latitude is allowed for and a highly-functional encapsulated material suitable for usage can be obtained;

(E) a particle having a uniform surface state can be produced;

(F) encapsulation on the nano order is facilitated;

(G) production of a polymerization by-product not having a core substance in the core is suppressed, and an encapsulated material having a particle size proportional to the amount added of the hydrophobic monomer used can be stably obtained;

(H) environment-friendly, that is, an adverse effect on the environment is lessened, because the production method of the present invention does not use an organic solvent harmful to the living body and can be practiced by a reaction in an aqueous system; and

(I) a core substance having toxicity or the like can be rendered low-toxic or harmless by the encapsulation.

Also, the encapsulated material of the present invention is useful particularly as an additive for an ink and provides the following effects (i) to (v):

(i) when used as a color material for inks, the dispersion stability in an aqueous liquid dispersion is excellent;

(ii) when formed into an ink, a recorded material with an image having excellent fastness can be obtained;

(iii) when formed into an ink, a recorded material with an image having excellent scratch resistance can be obtained;

(iv) when formed into an ink for inkjet recording, the ejection stability from a recording head is excellent; and

(v) when formed into an ink for inkjet recording, the image quality is excellent.

### BRIEF DESCRIPTION OF THE DRAWINGS

FIG. 1 is a schematic view showing the state where a core substance having an electric charge on its surface (the core substance itself has a negative charge on its surface) is dispersed in an aqueous medium and at the same time, coexists with an ionic monomer (3), an ionic polymerizable surfactant B (4) and a hydrophobic monomer (5).

FIG. 2 is a schematic view showing the state where in the dispersion state shown in FIG. 1, the ionic monomer (3), the ionic polymerizable surfactant B (4) and the hydrophobic monomer (5) are polymerized.

FIG. 3 is a schematic view showing the state where a core substance having adsorbed to the surface thereof an anionic surfactant (2) (a core substance having an electric charge on its surface) is dispersed in an aqueous medium and at the same time, coexists with an ionic monomer (3), an ionic polymerizable surfactant B (4) and a hydrophobic monomer (5).

FIG. 4 is a schematic view showing the state where in the dispersion state shown in FIG. 3, the ionic monomer (3), the ionic polymerizable surfactant B (4) and the hydrophobic monomer (5) are polymerized.

FIG. 5 is a schematic view showing the dispersion state of each substance when in the dispersion state shown in FIG. 3, a nonionic polymerizable surfactant C (8) is further used.

FIG. 6 is a comparison graph of the particle size distribution of Cyan Pigment P2, the expected particle size distribution (calculated value) of the encapsulated material obtained using Cyan Pigment P2 as the core substance, and the particle size distribution of each of Encapsulated Materials M2 (Example 2), M6 (Example 6) and H2 (Comparative Example 2) actually obtained using Cyan Pigment P2 as the core substance.

The reference numerals used in the drawings denote the followings, respectively.

1: Core substance, 2: anionic surfactant, 3: ionic (cationic) monomer, 4: ionic (anionic) polymerizable surfactant B, 5: hydrophobic monomer, 8: nonionic polymerizable surfactant, 21 and 41: anionic group, 22, 32, 42 and 82: hydrophobic group, 31: cationic group, 33, 43 and 83: polymerizable group, 60: wall material (polymer coat layer), 81: nonionic group, and 100: encapsulated material.

### DETAILED DESCRIPTION OF THE INVENTION

The encapsulated material of the present invention and the production method thereof are described in detail below.

One of the characteristic features of the present invention including the embodiments of [1] to [6] above is that in the production process of an encapsulated material, the ionic polymerizable surfactant A and/or ionic monomer, the hydrophobic monomer, the ionic polymerizable surfactant B are added and mixed to an aqueous solvent containing the core substance and an admicell which is a configuration form of these components very highly controlled on the core substance is thereby formed before the initiation of polymerization (before the step 4a or 4b starts).

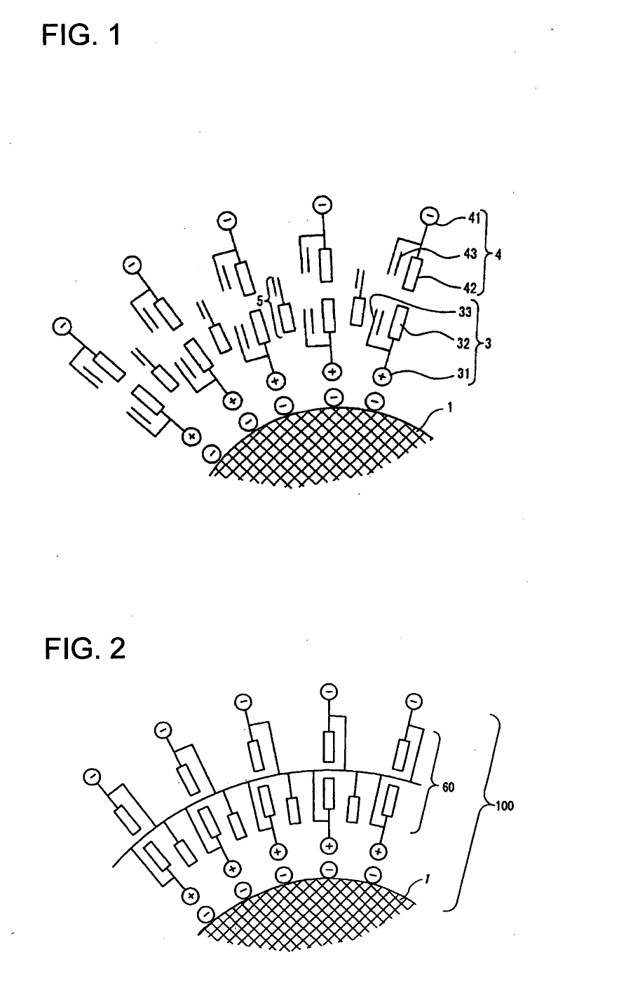

FIG. 1 is a schematic view showing one example of the admicell present in the mixed solution passed through the steps 1, 2a and 3a or through the steps 1, 2b and 3b.

A core substance 1 has a negative charge on its surface and is dispersed in a solvent mainly comprising water (aqueous solvent). A cationic monomer 3 (ionic monomer) having a cationic group 31, a hydrophobic group 32 and a polymerizable group 33 adsorbs to the core substance 1 through a strongly ionic bond by allowing the cationic group 31 to face the negative charge on the core substance surface. Furthermore, the hydrophobic group 42 and polymerizable group 43 of an anionic polymerizable surfactant 4 (ionic polymerizable surfactant B) having an anionic group 41, a hydrophobic group 42 and a polymerizable group 43 face the hydrophobic group 32 and polymerizable group 33 of the cationic monomer 3, and the anionic group 41 of the anionic polymerizable surfactant 4 locates in the direction where the aqueous solvent is present, that is, in the direction most remote from the core substance 1. The hydrophobic monomer 5 is present in the hydrophobic phase formed resulting from the hydrophobic group 32 and polymerizable group 33 of the cationic monomer 3 facing the hydrophobic group 42 and polymerizable group 43 of the anionic polymerizable surfactant 4.

According to the step 4a or 4b, a polymerization initiator is added and mixed to the solvent where an admicell shown in FIG. 1 is present (the mixed solution passed through the steps 1, 2a and 3a or the mixed solution passed through the steps 1, 2b and 3b), as a result, the cationic monomer 3, anionic polymerizable surfactant 4 and hydrophobic monomer are polymerized to form a polymer and, as shown in FIG. 2, an encapsulated material 100 of the present invention having a construction that the core substance 1 is coated with a wall material 60 mainly comprising the polymer is produced. Here, anionic groups 41 present on the surface of the wall material 60 are regularly and densely oriented toward the aqueous phase side, and this enables very good dispersion of the encapsulated material 100 in the aqueous medium.

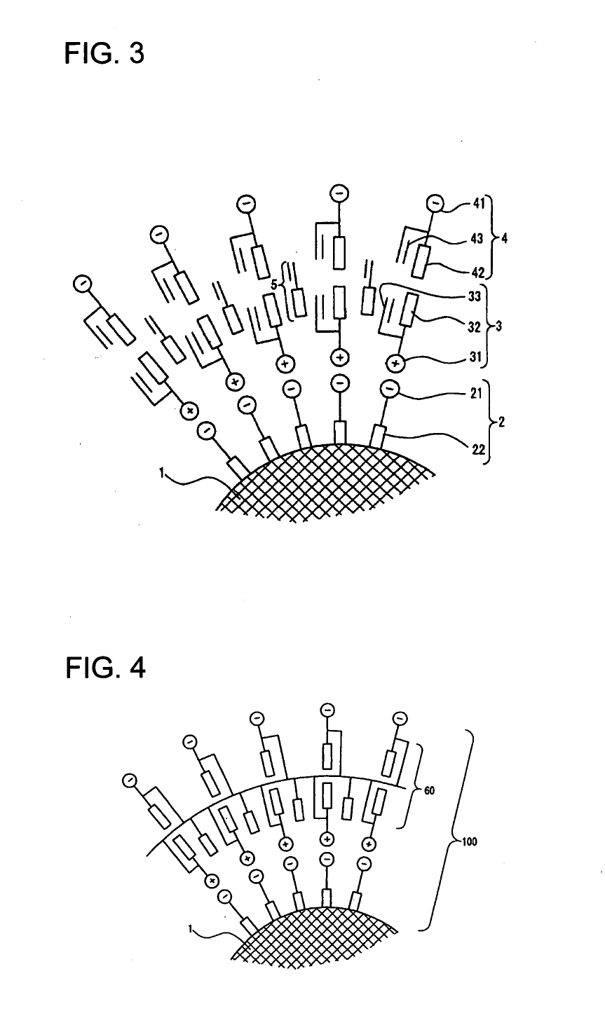

FIG. 3 is a schematic view showing another example of the admicell present in the mixed solution passed through the steps 1, 2a and 3a or through the steps 1, 2b and 3b, and FIG. 4 is a schematic view showing a state where various monomers are polymerized in the dispersion state shown in FIG. 3. The configuration of FIGS. 3 and 4 is the same as the configuration shown in FIGS. 1 and 2 except that an ionic (anionic) surfactant 2 having an ionic (anionic) group 21 and a hydrophobic group 22 is adsorbing to the surface of the core substance 1, and the description in FIGS. 1 and 2 applies to the same numerals as those of FIGS. 1 and 2.

In this way, a polymerization method comprising the steps 1, 2a and 3a or the steps 1, 2b and 3b is utilized in the present invention, whereby various components constituting the wall material (the ionic polymerizable surfactant A and/or ionic monomer, the ionic polymerizable surfactant B and the hydrophobic monomer) are very highly controlled in the periphery of the core substance at the stage before polymerization and an admicell in the state of the ionic groups in the outermost shell being oriented toward the aqueous phase is formed. In the step 4a or 4b, various components are polymerized into a polymer while maintaining the configuration of the admicell, and the wall material is formed, as a result, an encapsulated material having a structure controlled with very high precision can be obtained. Such an encapsulated material can satisfy all of (A) to (I) above and (i) to (v) above.

Incidentally, an encapsulated material satisfying all of (A) to (I) above and (i) to (v) above cannot be obtained by a production method of an encapsulated material other than the above-described polymerization method, for example, by a phase inversion emulsification method or an acid precipitation method. The reason therefor is not known but is presumed because in the phase inversion emulsification method, acid precipitation method or the like, a previously produced polymer is used as the wall material coating the core substance and the coated state with the wall material for the core substance is not complete (the core substance is not completely covered with the wall material). Also, in the case of the phase inversion emulsification method, since an organic solvent is used in the production process, the organic solvent used may remain and when the encapsulated material by the phase inversion emulsification method is used for the coating material or ink, there may arise a problem in the performance stability. Particularly, when the encapsulated material by the phase inversion emulsification method is used for the inkjet pigment ink, for example, the dispersion stability or ejection stability of ink or the image quality obtained sometimes fluctuates or deterioration or the like of a plastic member is sometimes caused. The encapsulated material of the present invention ensures stable performance because of no use of an organic solvent in the production process and does not bring about deterioration or the like of a plastic member.

Another characteristic feature of the present invention is that in the production process of an encapsulated material, the amount of the ionic polymerizable surfactant B added to the mixed solution in the step 3a or 2b is adjusted such that the concentration of the ionic polymerizable surfactant B becomes the critical micell concentration for the water amount in the final mixed solution finally obtained in the step 3a or 3b. The final mixed solution is a mixed solution immediately before a polymerization initiator is added in the step 4a or 4b, that is, a reaction solution before the initiation of polymerization, and when other components (for example, an alcohol or a nonionic polymerizable surfactant) are added to the mixed solution in addition to the ionic polymerizable surfactant A and/or ionic monomer, the ionic polymerizable surfactant B and the hydrophobic monomer, the final mixed solution is containing these other components. The critical micell concentration (CMC) is as well known the minimum surfactant concentration necessary for forming a micell and is a numerical value inherent to a surfactant. In this way, the polymerization reaction (the step 4a or 4b) is performed by setting the concentration of the ionic polymerizable surfactant B in the final mixed solution to the critical micell concentration of the ionic polymerizable surfactant B for the water content in the final mixed solution, whereby the production of a polymerization by-product not having a core substance in the core (polymer particle) is effectively suppressed, so that a wall material thickness proportional to the amount of a hydrophobic monomer added to the reaction system can be obtained and an encapsulated material having a large particle size unobtainable by the conventional encapsulation method can be stably obtained. Incidentally, in the present invention, as for the components (the ionic polymerizable surfactants A and B and ionic monomer) other than the hydrophobic monomer, the amount added to the reaction system is usually by far smaller as compared with the hydrophobic monomer and the thickness of the wall material is substantially not affected by whether the amount of these other polymerization components in the reaction system is large or small.

In the present invention, the critical micell concentration of the ionic polymerizable surfactant is obtained from the results when the ionic polymerizable surfactant is added and mixed to a solvent (a solvent of the same species as the solvent used in the production of the encapsulated material of the present invention, that is, water) to prepare a plurality of samples differing in the concentration and the surface tension of samples having various concentrations is measured at 25° C.

In this way, the amount of the ionic polymerizable surfactant B added in the step 3a or 2b is determined based on the critical micell concentration of the ionic polymerizable surfactant B for the water amount in the final mixed solution, and the specific numerical value of the amount added varies depending on the ionic polymerizable surfactant used.

The above-described steps each is described in detail below.

Before practicing the step 1, a step of preparing a solvent containing “a core substance having an electric charge on its surface” is performed as a preparatory step. As for the “core substance having an electric charge on its surface”, a substance originally having an electric charge on its surface as well as a substance obtained by introducing a functional group or chemical substance having an electric charge (surface-treated substance) with use of a chemical reaction or a physical action such as adsorption into a substance originally not having an electrical charge on its surface or if any, having a very low electric charge (for example, an insulating material or an organic pigment), may be used. Specific examples of the surface-treated substance include those described in “Surface Treatment of Pigment Particle with Hydrophilic Group-Imparting Agent” of paragraphs [0036] to [0056] of JP-A-2005-97476 previously filed by the present applicant.

For example, in the case of producing “a core substance having adsorbed to the surface thereof an ionic surfactant having an ionic group and a hydrophobic group” like the core substance 1 shown in FIG. 3, when the core substance is a solid matter such as pigment particle, the ionic surfactant is preferably adsorbed to the core substance surface by adding and mixing the core substance to ion exchanged water having dissolved therein the ionic surfactant and subjecting the resulting mixed solution to a dispersion treatment in a general dispersing machine such as ball mill, roll mill, Eiger mill or jet mill. Furthermore, the mixed solution after the dispersion treatment is preferably subjected to ultrafiltration or the like to reduce the ionic surfactant not adsorbed to the core substance. If the unadsorbed ionic surfactant is present in a large amount, the amount of a polymer particle produced as a by-product increases and insufficient encapsulation of the core substance may result. However, if the unadsorbed ionic surfactant is excessively removed, the dispersion of the core substance sometimes becomes unstable. Therefore, an appropriate degree of ultrafiltration or the like is preferably determined by taking into account the dispersion stability and encapsulated condition of the core substance.

The substance adsorbed to the surface of the core substance is not limited to the above-described “ionic surfactant having an ionic group and a hydrophobic group” but may be, for example, “an ionic polymerizable surfactant having an ionic group, a hydrophobic group and a polymerizable group”, “a nonionic surfactant having a nonionic group and a hydrophobic group” or “a nonionic polymerizable surfactant having a nonionic group, a hydrophobic group and a polymerizable group”, and an appropriate core substance may be selected from these substances by taking into consideration the dispersibility of the core substance in the dispersion medium.

The aqueous solvent of the “aqueous solvent containing a core substance having an electric charge on its surface” in the step 1 is a solvent mainly comprising water, such as deionized water. The aqueous solvent may contain various auxiliaries for aiding the dispersion of the core substance in water, a water-soluble organic solvent for aiding the storage stability of the aqueous solvent containing “a core substance having an electric charge on its surface”, or the like, if desired.

In the step 1, the amount of the ionic polymerizable surfactant A and/or ionic monomer added to the aqueous solvent containing “a core substance having an electric charge on its surface” is preferably from 0.5 to 2 times by mol, more preferably from 0.8 to 1.2 times by mol, based on the total molar number of the ionic group on the core substance surface (that is, the amount [mol/g] of the ionic group present on the core substance surface per g of the core substance used). Within the range from 0.5 to 2 times by mol, the electrostatic interaction between the ionic group on the core substance surface and the ionic group having an opposite electric charge of the ionic polymerizable surfactant A and/or ionic monomer enters a suitable state, and the core substance suitably coated with the ionic polymerizable surfactant A and/or ionic monomer becomes hydrophobic, as a result, formation of an admicell in the step 2a or 2b and subsequent steps is facilitated. Particularly, within the range from 0.8 to 1.2 times by mol, a more suitable state is established and the encapsulated material can be obtained at a high yield.

In the step 1, from the standpoint of promoting uniform adsorption of the ionic polymerizable surfactant A and/or ionic monomer to the core substance surface, after the ionic polymerizable surfactant A and/or ionic monomer is added and mixed to the aqueous solvent containing the core substance, the mixed solution (aqueous solvent containing the core substance) obtained is preferably irradiated with an ultrasonic wave. As for the irradiation conditions of an ultrasonic wave here, the irradiation frequency and irradiation time are determined by taking into consideration the kind of core substance, the degree of adsorption of the ionic polymerizable surfactant A and/or ionic monomer to the core substance surface, the degree of aggregation of the core substance, and the like.

Incidentally, it is not preferred to irradiate an ultrasonic wave after the step 1, because the yield of the encapsulated material is liable to decrease due to increase in the production of a polymer particle resulting from destroy of the admicell formed and the particle size distribution of the encapsulated material obtained is readily broadened to make it difficult to obtain the objective particle size.

After the step 1, (1) a step of adding and mixing a specific amount of an ionic polymerizable surfactant B (step 3a) may be performed through a step of adding and mixing a hydrophobic monomer to the mixed solution passed through the step 1 (step 2a), or (2) a step of adding and mixing a hydrophobic monomer (step 3b) may be performed through a step of adding and mixing a specific amount of an ionic polymerizable surfactant B to the mixed solution passed through the step 1 (step 2b). That is, in the present invention, as for the order of adding the hydrophobic monomer and the ionic polymerizable surfactant B to the mixed solution, either one may be added first.

The hydrophobic monomer used in the step 2a or 3b is a component indispensable for controlling the film-forming property of encapsulated material and the strength, chemical resistance, water resistance, light resistance, weather resistance, optical properties, and other physical and chemical properties of wall material. Particularly, in the case of using the encapsulated material as a color material in the ink for inkjet recording, utilization of the hydrophobic monomer in the production of the encapsulated material is very effective in view of satisfying the requisite characteristics such as fixing property of color material, scratch resistance of printed part, water resistance and solvent resistance. In the case of using the encapsulated material as an electrophotographic toner, the hydrophobic monomer is selected by taking into consideration the offset property, electrical properties and the like as well as the fixing property and scratch resistance.

In the step 2a or 3b, the total amount of the hydrophobic monomer added is determined according to the desired particle size of the encapsulated material. More specifically, the necessary amount of the hydrophobic monomer is determined from the density of coat polymer (polymer constituting the wall material) and the amount of coat polymer, which are obtained from the desired particle size of the encapsulated material and the particle size of the core substance, and the total amount of the hydrophobic monomer added is determined based on the resulting value.

In the step 2a or 3b, in addition to the hydrophobic monomer, a higher alcohol having a carbon number of 6 or more may be added and mixed to the mixed solution. When the higher alcohol having a carbon number of 6 or more is added and mixed to the mixed solution, the higher alcohol is solubilized in the admicell and at the same time, aids the solubilization of the hydrophobic monomer in the admicell, so that the thickness of the wall material coating the core substance can be increased. The addition of the higher alcohol having a carbon number of 6 or more is also effective in making the particle size distribution of the encapsulated material to have a sharp width. Furthermore, the higher alcohol having a carbon number of 6 or more is present in the polymer constituting the wall material of the encapsulated material and acts like a plasticizer on the polymer and therefore, an encapsulated material with excellent film-forming property is obtained by the addition of the higher alcohol. Also, the higher alcohol present in the polymer constituting the wall material less migrates to the aqueous medium present in the periphery of the encapsulated material, so that the encapsulated material can maintain the stable dispersion state in the aqueous medium over a long period of time.

In this way, in the present invention, by using a higher alcohol having a carbon number of 6 or more, more preferred results are obtained in terms of large thickness of the wall material (polymer coat layer coating the core substance), sharp width of the particle size distribution of the encapsulated material, film-forming property of the encapsulated material, and enhanced dispersion stability of the encapsulated material in the aqueous medium.

Accordingly, the encapsulated material of the present invention obtained using a higher alcohol having a carbon number of 6 or more is effective particularly for usage requiring dispersion stability of the encapsulated material in the aqueous medium or film-forming property, for example, in usage for inkjet recording. For example, when the encapsulated material of the present invention obtained using a higher alcohol having a carbon number of 6 or more is used as a color material in the inkjet recording ink, good results are obtained in terms of the ejection stability and the scratch resistance and gloss of printed image.

The higher alcohol having a carbon number of 6 or more for use in the present invention is preferably a higher alcohol which acts as a surfactant when used together with an ionic polymerizable surfactant and/or a nonionic polymerizable surfactant, and examples thereof isostearyl alcohol, hexanol, oleyl alcohol, octyl dodecanol, oleyl alcohol, chimyl alcohol, cholesterol, sitosterol, palmityl alcohol, setostearyl alcohol, selachyl alcohol, decyl tetradecanol, batyl alcohol, hexyl decanol, behenyl alcohol, lanolin alcohol, octyl alcohol, nonyl alcohol, decyl alcohol, undecyl alcohol, dodecyl alcohol (also known as lauryl alcohol or decanol), tridecyl alcohol, tetradecyl alcohol (also known as myristyl alcohol), pentadecyl alcohol, hexadecyl alcohol (also known as cetyl alcohol), heptadecyl alcohol, octadecyl alcohol (also known as stearyl alcohol), docosanol, eicosanol, hexacosanol, nonadecanol, octacosanol, tetracosanol and tricosanol. One of these alcohols may be used alone or two or more thereof may be mixed and used.

The amount of the higher alcohol added is preferably from 0.5 to 25 wt %, more preferably from 1 to 10 wt %, based on the weight of the hydrophobic monomer added to the mixed solution. If the amount of the higher alcohol added is less than 0.5 wt % based on the hydrophobic monomer, the expected effects can be hardly obtained, whereas if it exceeds 25 wt % based on the hydrophobic monomer, the polymer constituting the wall material comes to have excessively high plasticity and when the encapsulated material is used in the inkjet recording ink, the ejection stability or image quality is liable to deteriorate.

In the step 3a, the ionic polymerizable surfactant B is added and mixed to the mixed solution passed through the step 2a. Similarly, in the step 2b, the ionic polymerizable surfactant B is added and mixed to the mixed solution passed through the step 1. The amount of the ionic polymerizable surfactant B added in the step 3a or 2b is, as described above, an amount such that the concentration of the ionic polymerizable surfactant B in the final mixed solution finally obtained in the step 3a or 3b becomes equal to the critical micell concentration of the ionic polymerizable surfactant B for the water amount in the final mixed solution.

It is presumed that by sequentially passing (1) through the steps 1, 2a and 3a or (2) through the steps 1, 2b and 3b in this way, the ionic polymerizable surfactant A and/or ionic monomer having an electric charge opposite the electric charge on the surface of the core substance are electrostatically adsorbed to the surface of the core substance having an electric charge on its surface, the hydrophobic monomer is localized on the outer side thereof, and the ionic polymerizable surfactant B is oriented on the further outer side thereof by allowing the ionic group to face the aqueous phase side, whereby an admicell is formed. And, an encapsulated material having a particle size (thickness of the wall material) proportional to the amount of the hydrophobic monomer added to the reaction system can be finally obtained. A polymerization by-product not having a core substance in the core is hardly produced and in turn, the encapsulated material can be obtained at a high yield.

In the present invention, if desired, a polymerization component other than the polymerization components described above (ionic polymerizable surfactant A and/or ionic monomer, hydrophobic monomer and ionic polymerizable surfactant B) may be used in the production process of the encapsulated material, within the range not impairing the effects of the present invention. In this case, an ultrasonic wave is preferably irradiated on the aqueous medium (mixed solution) containing the core substance after the other polymerization component is added.

In the step 3a, “a nonionic polymerizable surfactant having a nonionic group, a hydrophobic group and a polymerizable group” may be further added and mixed to the mixed solution passed through the step 2a, in addition to the ionic polymerizable surfactant B. Similarly, in the step 2b, the nonionic polymerizable surfactant above may be further added and mixed to the mixed solution passed through the step 1, in addition to the ionic polymerizable surfactant B.

Use of the nonionic polymerizable surfactant enables the control of charge amount on the surface of the encapsulated material. For example, the zeta potential of the encapsulated material dispersed in water can be changed by the amount of the nonionic polymerizable surfactant added. Also, in the case where an encapsulated material using a color material particle such as pigment for the core substance is used as a color material of the inkjet recording ink, high color formability and high printing density can be obtained on plain paper and at the same time, high gloss and high image clarity can be obtained on the inkjet special paper.

In the step 3a or 2b, the nonionic polymerizable surfactant is preferably added in an amount such that the concentration of the nonionic polymerizable surfactant in the final mixed solution finally obtained in the step 3a or 3b becomes equal to the critical micell concentration of the nonionic polymerizable surfactant for the water amount in the final mixed solution.

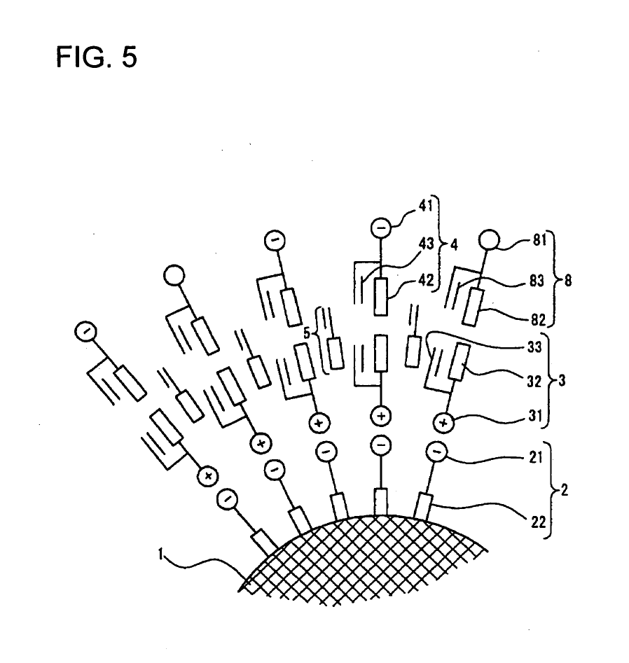

FIG. 5 shows the state of an admicell which can be formed when the nonionic polymerizable surfactant is used. Out of the numerals in FIG. 5, the description in FIGS. 1 to 4 applies to the same numerals as those of FIGS. 1 to 4.

In the admicell shown in FIG. 5, by the hydrophobic interaction, the hydrophobic group 82 and polymerizable group 83 of the nonionic polymerizable surfactant 8 as well as the hydrophobic group 42 and polymerizable group 43 of the anionic polymerizable surfactant 4 (ionic polymerizable surfactant B) respectively face the hydrophobic group 32 and polymerizable group 33 of the cationic monomer 3 (ionic monomer) adsorbed to the surface of the core substance 1 through the anionic surfactant 2 and at the same time, the anionic group 41 of the anionic polymerizable surfactant 4 and the nonionic group 81 of the nonionic polymerizable surfactant 8 each locates in the direction where the aqueous medium is present, that is, in the direction most remote from the core substance 1. The hydrophobic monomer 5 is present in the hydrophobic phase formed resulting from the hydrophobic group 32 and polymerizable group 33 of the cationic monomer 3 facing the hydrophobic group 42 and polymerizable group 43 of the anionic polymerizable surfactant 4 or facing the hydrophobic group 82 and polymerizable group 83 of the nonionic polymerizable surfactant 8. The encapsulated material of the present invention can also be suitably produced by passing through the formation of such an admicell.

In the step 4a, the polymerization reaction is performed in a reaction vessel equipped with a stirrer, a reflux condenser, a dropping funnel and a temperature regulator by adding and mixing a polymerization initiator to the mixed solution passed through the step 3a. Similarly, in the step 4b, the polymerization reaction is performed in a reaction vessel equipped with the same devices as above by adding and mixing a polymerization initiator to the mixed solution passed through the step 3b.

As for the addition of the polymerization initiator to the solvent, the polymerization initiator may be added en bloc or in parts to the solvent heated to a temperature at which the polymerization initiator is activated, or may be added continuously. Also, after the addition of the polymerization initiator, the solvent may be heated to a temperature at which the polymerization initiator is activated. The polymerization initiator includes a water-soluble polymerization initiator which is soluble in water, and an oil-soluble polymerization initiator which is insoluble or sparingly soluble in water, and either polymerization initiator may be used in the present invention. In the case of using a water-soluble polymerization initiator, the polymerization reaction may be suitably performed by adding dropwise an aqueous solution obtained by dissolving the water-soluble polymerization initiator in ion exchanged water, to the solvent in the reaction vessel at a predetermined dropwise addition rate. In the case of using an oil-soluble polymerization initiator, the polymerization reaction may be suitably performed by adding the polymerization initiator to the solvent in the reaction vessel directly or after dissolving it in the hydrophobic monomer.

The amount of the polymerization initiator added is preferably from 1 to 5 wt %, more preferably from 1 to 3 wt %, based on the total weight of the polymerization components added (the ionic polymerizable surfactant A and/or ionic monomer, the hydrophobic monomer, the ionic polymerizable surfactant B, the nonionic polymerizable surfactant and other polymerization components). If the amount added is less than 1 wt %, the polymerization reaction may not sufficiently proceed, whereas if the amount added exceeds 5 wt %, gelling, aggregation or the like may occur.

The polymerization initiator may be suitably activated by elevating the temperature of the reaction system to a temperature at which the polymerization initiator is cleaved to generate an initiator radical. As a result of cleavage of the polymerization initiator added, an initiator radical is generated, and this initiator radical attacks the polymerizable group of the ionic monomer, ionic polymerizable surfactant or hydrophobic monomer and depending on the case, attacks the polymerizable group of the nonionic polymerizable surfactant or other polymerization components, whereby a polymerization reaction takes place. The polymerization temperature and polymerization reaction time vary depending on the kind of the polymerization initiator used and the kind of the polymerizable monomer, but it is easy for one skilled in the art to appropriately set preferred polymerization conditions. In general, the polymerization temperature is preferably from 40 to 90° C., and the polymerization time is preferably from 3 to 12 hours.

In the polymerization reaction performed in the step 4a or 4b, if desired, one or more members selected from the group consisting of known anionic, nonionic and cationic emulsifiers may be used. However, in the case of using such an emulsifier, an emulsifier having the same electric charge as that of the ionic polymerizable surfactant B or a nonionic emulsifier must be used. If an emulsifier having an electric charge different from that of the ionic polymerizable surfactant B is used, gelling or aggregation occurs and this is not preferred.

After the completion of the step 4a or 4b (after the completion of polymerization), the obtained aqueous liquid dispersion of the encapsulated material is preferably adjusted to a pH of 7.0 to 9.0 when an anionic polymerizable surfactant is used, or to a pH of 4.0 to 6.0 when a cationic polymerizable surfactant is used. The resulting dispersion is preferably further filtered. The filtration is preferably ultrafiltration.

In the aqueous liquid dispersion of the encapsulated material produced (1) through the steps 1, 2a, 3a and 4a or (2) through the steps 1, 2b, 3b and 4b, the encapsulated material has high dispersion stability in the aqueous solvent and this is considered to result because the core substance is completely covered (there is no uncovered portion) with a wall material mainly comprising a polymer and at the same time, the hydrophilic groups in the polymer constituting the wall material are regularly oriented toward the aqueous solvent.

The thus-obtained aqueous liquid dispersion of an encapsulated material sometimes contains not only an encapsulated material but also an unreacted monomer (a monomer not used for the reaction or a by-product such as polymerizable compound) derived from the monomer used for the production of the encapsulated material (e.g., ionic polymerizable surfactant A and/or ionic monomer, hydrophobic monomer, ionic polymerizable surfactant B, nonionic polymerizable surfactant) and therefore, the aqueous liquid dispersion is preferably purified to reduce the concentration of the unreacted monomer. In the case where the aqueous liquid dispersion after the purification treatment is used particularly for the inkjet recording ink, a high-quality image with high color saturation, high print density (printing density) and suppressed generation of blurring can be output on plain paper. Furthermore, an image with good gloss can be output on an inkjet recording special medium, particularly, on an inkjet gloss medium.

For purifying the encapsulated material-containing aqueous liquid dispersion, a method such as centrifugal separation and ultrafiltration may be used.

The amount of the unreacted monomer contained in all components other than the solid content of the encapsulated material-containing aqueous liquid dispersion after the purification treatment is preferably 50,000 ppm or less, more preferably 10,000 ppm or less. The amount of the unreacted monomer can be easily measured by using a sample containing the unreacted monomer in a known concentration and using the gas or liquid chromatography of the sample measured.

In the foregoing pages, the production method of an encapsulated material where the wall material (polymer coat layer) coating the core substance has a single-layer structure is described, but the polymer coat layer in the encapsulated material of the present invention may be constructed in a multilayer structure by stacking two or more layers. In this case, for example, referring to an encapsulated material with the polymer coat layer having a two-layer structure, first, (1) “an ionic polymerizable surfactant A and/or ionic monomer having an ionic group with an electric charge opposite the electric charge on the core substance surface, a hydrophobic group and a polymerizable group” is added and mixed to an aqueous solvent containing “a core substance having an electric charge on its surface” to adsorb the ionic polymerizable surfactant A and/or ionic monomer to the surface of the core substance, (2) a hydrophobic monomer is added and mixed, (3) “an ionic polymerizable surfactant B having an ionic group with an electric charge the same as or opposite the electric charge on the core substance surface, a hydrophobic group and a polymerizable group” is added and mixed such that the concentration of the ionic polymerizable surfactant B in the final mixed solution finally obtained in this step (3) becomes the critical micell concentration of the ionic polymerizable surfactant B for the water amount in the final mixed solution, and (4) a polymerization initiator is added to polymerize the ionic polymerizable surfactant A and/or ionic monomer, the hydrophobic monomer and the ionic polymerizable surfactant B in water, thereby obtaining an encapsulated material having a first polymer coat layer. Subsequently, (5) “an ionic polymerizable surfactant C and/or ionic monomer having an electric charge opposite the electric charge on the surface of the first polymer coat layer” is added and mixed to the aqueous liquid dispersion of the encapsulated material having a first polymer coat layer, (6) a hydrophobic monomer is added and mixed, (7) “an ionic polymerizable surfactant D having an electric charge the same as or opposite the electric charge on the surface of the first polymer coat layer” is added and mixed such that the concentration of the ionic polymerizable surfactant D in the final mixed solution finally obtained in this step (7) becomes the critical micell concentration of the ionic polymerizable surfactant D for the water amount in the final mixed solution, and (8) a polymerization initiator is added to polymerize the ionic polymerizable surfactant C and/or ionic monomer, the hydrophobic monomer and the ionic polymerizable surfactant D in water to form a second polymer coat layer, whereby an encapsulated material having a first polymer coat layer and a second polymer coat layer on the core substance can be suitably produced. An encapsulated material with the polymer coat layer having a multilayer structure of three or more layers can be suitably produced according to the above-described method by sequentially forming polymer coat layers on the core substance. Incidentally, as for the ionic polymerizable surfactant C, those similar to the ionic polymerizable surfactant A may be used, and as for the ionic polymerizable surfactant D, those similar to the ionic polymerizable surfactant B may be used.

In the production method of the encapsulated material of the present invention having a polymer coat layer (wall material) composed of a plurality of layers, addition of the above-described higher alcohol having a carbon number of 6 or more is effective. The timing of adding the higher alcohol is not particularly limited but is preferably, in the process of forming each of the first coat layer and the second coat layer, before adding a polymerizable initiator, that is, before polymerization. More specifically, in the formation of the first polymer coat layer, the higher alcohol is preferably added after the step (2) but before the step (3), and in the formation of the second polymer coat layer, the higher alcohol is preferably added after the step (6) but before the step (7). Depending on the polymer coat layer during which formation the higher alcohol is added, the sphericity of the encapsulated material can be controlled and at the same time, the film-forming property of the encapsulated material can also be controlled.

Various raw materials used in the production method of the present invention are described below.

### [Core Substance]

The core substance for use in the present invention is not particularly limited, but examples thereof include a color material, an inorganic material, an organic material, an inorganic-organic composite particle, an inorganic colloid, a polymer particle and a metal oxide (e.g., silica, titania), and these substances may be used individually or in combination of two or more thereof. For example, when a dangerous drug or the like is intended to use as the organic material, the encapsulated material of the present invention provides an effect of improving the handleability of such a dangerous drug or the like. The inorganic-organic composite particle when used as a filler of a resin shaped article or the like can enhance the property of the shaped article. The inorganic colloid can be used for a hardcoat layer having high transparency. The color material includes a pigment such as inorganic or organic pigment capable of forming a desired color, and a dye insoluble or sparingly soluble in water, such as disperse dye and oil-soluble dye. In the case of producing an encapsulated material by using a color material as the core substance, the encapsulated material can be used as a colorant for a coating material, a pigment ink, a toner or the like. The method for imparting an electric charge to the core substance surface is as described above.

Examples of the inorganic pigment (color material) usable as the core substance include carbon blacks (C.I. Pigment Black 7) such as furnace black, lamp black, acetylene black and channel black, and an iron oxide pigment.

Examples of the organic pigment (color material) usable as the core substance include an azo pigment (e.g., azo lake, insoluble azo pigment, condensed azo pigment, chelate azo pigment), a polycyclic pigment (e.g., phthalocyanine pigment, perylene pigment, perinone pigment, anthraquinone pigment, quinacridone pigment, dioxane pigment, thioindigo pigment, isoindolinone pigment, quinofuranone pigment), a dye chelate (e.g., basic dye-type chelate, acidic dye-type chelate), a nitro pigment, a nitroso pigment and aniline black.

More specifically, examples of the inorganic pigment used for black include the following carbon black: No. 2300, No. 900, MCF88, No. 33, No. 40, No. 45, No. 52, MA7, MA8, MA100 and No. 2200B produced by Mitsubishi Chemical Co. Ltd.; Raven 5750, Raven 5250, Raven 5000, Raven 3500, Raven 1255 and Raven 700 produced by Columbia; Regal 400R, Regal 330R, Regal 660R, Mogul L, Monarch 700, Monarch 800, Monarch 880, Monarch 900, Monarch 1000, Monarch 1100, Monarch 1300 and Monarch 1400 produced by Cabot; Color Black FW1, Color Black FW2, Color Black FW2V, Color Black FW18, Color Black FW200, Color Black S150, Color Black S160, Color Black S170, Printex 35, Printex U, Printex V, Printex 140U, Special Black 6, Special Black 5, Special Black 4A and Special Black 4 produced by Degussa.

The organic pigment for black includes a black organic pigment such as aniline black (C.I. Pigment Black 1).

Examples of the organic yellow pigment include C.I. Pigment Yellow 1 (Hansa Yellow), 2, 3 (Hansa Yellow 10G), 4, 5 (Hansa Yellow 5G), 6, 7, 10, 11, 12, 13, 14, 16, 17, 24 (Flavanthrone Yellow), 34, 35, 37, 53, 55, 65, 73, 74, 75, 81, 83, 93, 94, 95, 97, 98, 99, 108 (Anthrapyrimidine Yellow), 109, 110, 113, 117 (copper complex salt pigment), 120, 124, 128, 129, 133 (Quinophthalone), 138, 139 (Isoindolinone), 147, 151, 153 (nickel complex pigment), 154, 167, 172 and 180.

Examples of the organic magenta pigment include C.I. Pigment Red 1 (Para Red), 2, 3 (Toluidine Red), 4, 5 (1TR Red), 6, 7, 8, 9, 10, 11, 12, 14, 15, 16, 17, 18, 19, 21, 22, 23, 30, 31, 32, 37, 38 (Pyrazolone Red), 40, 41, 42, 48 (Ca), 48 (Mn), 57 (Ca), 57:1, 88 (Thioindigo), 112 (Naphthol AS type), 114 (Naphthol AS type), 122 (Dimethylquinacridone), 123, 144, 146, 149, 150, 166, 168 (Anthoanthrone Orange), 170 (Naphthol AS type), 171, 175, 176, 177, 178, 179 (Perylene Maroon), 184, 185, 187, 202, 209 (Dichloroquinacridone), 219, 224 (perylene type) and 245 (Naphthol AS type); and C.I. Pigment Violet 19 (Quinacridone), 23 (Dioxazine Violet), 32, 33, 36, 38, 43 and 50.

Examples of the organic cyan pigment include C.I. Pigment Blue 1, 2, 3, 15, 15:1, 15:2, 15:3, 15:34, 15:4, 16 (metal-free phthalocyanine), 18 (alkali blue toner), 22, 25, 60 (Threne Blue), 65. (Violanthrone) and 66 (Indigo); and C.I. Vat Blue 4 and 60.

Examples of the organic pigment other than yellow, magenta and cyan include C.I. Pigment Green 7 (Phthalocyanine Green), 10 (Green Gold), 36 and 37; C.I. Pigment Brown 3, 5, 25 and 26; and C.I. Pigment Orange 1, 2, 5, 7, 13, 14, 15, 16, 24, 34, 36, 38, 40, 43 and 63.

The average particle size (diameter) of the core substance is preferably 150 nm or less, more preferably from 20 to 80 nm. The term “average particle size” as referred to herein means a value measured by a laser light scattering method. When an encapsulated material with the core substance having an average particle size in this range is used as a color material particularly for the inkjet recording ink, the dispersion stability and ejection stability are excellent and an image with high print density can be output.

### [Ionic Polymerizable Surfactant A]

The ionic polymerizable surfactant A is a polymerization component of the polymer which is the main component of the wall material coating the core substance, and has an ionic group with an electric charge opposite the electric charge on the core substance surface, a hydrophobic group and a polymerizable group.

The hydrophobic group is selected from the group consisting of a linear alkyl group having a carbon number of 8 to 16, a branched alkyl group having a carbon number of 8 to 16, an alkylbenzene (alkylphenyl group) or alkylnaphthalene (alkylnaphthyl group) having both an alkyl group and an aryl group in the molecule, and a polypropylene oxide group. The hydrophobic group may have both an alkyl group and an aryl group in the molecule.

The polymerizable group is preferably an unsaturated hydrocarbon group capable of radical polymerization and specifically, the polymerizable group is preferably a group selected from the group consisting of a vinyl group, an allyl group, an acryloyl group, a methacryloyl group, a propenyl group, a vinylidene group and a vinylene group. Among these, an aryl group, a methacryloyl group and an acryloyl group are preferred.

The ionic group includes a cationic group and an anionic group. The ionic polymerizable surfactant having a cationic group as the ionic group is called “a cationic polymerizable surfactant”, and the ionic polymerizable surfactant having an anionic group as the ionic group is called “an anionic polymerizable surfactant”. In the present invention, an ionic polymerizable surfactant A with an ionic group having an electric charge opposite the electric charge on the surface of the core substance is adsorbed to the core substance surface by utilizing electrostatic interaction. As for the ionic polymerizable surfactant A, either a cationic polymerizable surfactant or an anionic polymerizable surfactant is used according to the electric charge on the core substance surface.

The cationic polymerizable surfactant includes, for example, a compound represented by the formula: R_{[4-(1+m+n)]}R¹ₗR²ₘR³ₙN⁺.X⁻ (wherein R is a polymerizable group, R¹, R² and R³ each is an alkyl group having a carbon number of 8 to 16 or an aryl group such as phenyl group or phenylene group, X⁻ is Cl⁻, Br⁻, I⁻, CH₃OSO₃⁻ or C₂H₅OSO₃⁻, and l, m and n each is 1 or 0). Here, examples of the polymerizable group are the same as those described above.

Specific examples of the cationic polymerizable surfactant include dimethylaminoethyl methacrylate octylchloride salt, dimethylaminoethyl methacrylate cetylchloride salt, dimethylaminoethyl methacrylate decylchloride salt, dimethylaminoethyl methacrylate dodecylchloride salt and dimethylaminoethyl methacrylate tetradecylchloride salt.

In the present invention, one of these cationic polymerizable surfactants may be used alone, or two or more species thereof may be used as a mixture.

Specific examples of the anionic polymerizable surfactant include anionic allyl derivatives described in JP-B-49-46291, JP-B-1-24142 and JP-A-62-104802; anionic propenyl derivatives described in JP-a-62-221431; anionic acrylic acid derivatives described in JP-A-62-34947 and JP-A-55-11525; and anionic itaconic acid derivatives described in JP-B-46-34898 and JP-A-51-30284.

The anionic polymerizable surfactant for use in the present invention is preferably, for example, a compound represented by the following formula (31):

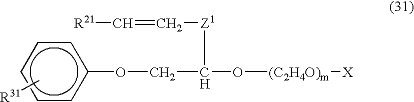

[wherein R²¹ and R³¹ each is independently a hydrogen atom or a hydrocarbon group having a carbon number of 1 to 12, Z¹ is a carbon-carbon single bond or a group represented by the formula: —CH₂—O—CH₂—, m is an integer of 2 to 20, X is a group represented by the formula: —SO₃M¹, and M¹ is an alkali metal, an ammonium salt or an alkanolamine], or a compound represented by the following formula (32):

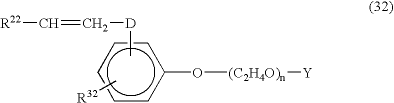

[wherein R²² and R³² each is independently a hydrogen atom or a hydrocarbon group having a carbon number of 1 to 12, D is a carbon-carbon single bond or a group represented by the formula: —CH₂—O—CH₂—, n is an integer of 2 to 20, Y is a group represented by the formula: —SO₃M², and M² is an alkali metal, an ammonium salt or an alkanolamine].

Examples of the compound (anionic polymerizable surfactant) represented by formula (31) include the compounds described in JP-A-5-320276 and JP-A-10-316909. The hydrophilicity on the surface of the encapsulated material obtained by encapsulating a core substance can be adjusted by appropriately adjusting the number of m in formula (31). The polymerizable surfactant represented by formula (31) is preferably a compound represented by the following formula (310), and specific examples thereof include the compounds represented by the following formulae (31a) to (31d).

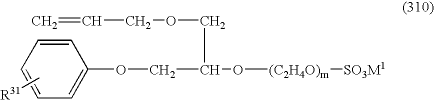

[wherein R³¹, m and M¹ are the same as those in the compound represented by formula (31)].

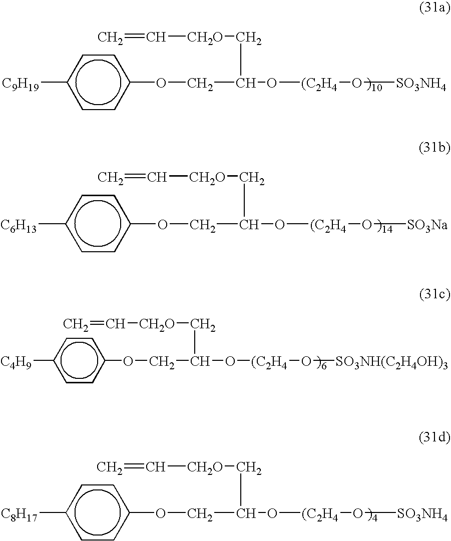

As regards the compound (anionic polymerizable surfactant) represented by formula (310), a commercially available product may also be used. For example, ADEKA REARSOPE SE-10N produced by Asahi Denka Co., Ltd. is a compound where in the compound represented by formula (310), M¹ is NH₄, R³¹ is C₉H₁₉ and m=10, and ADEKA REARSOPE SE-20N produced by Asahi Denka Co., Ltd. is a compound where in the compound represented by formula (310), M¹ is NH₄, R³¹ is C₉H₁₉ and m=20.

Also, the anionic polymerizable surfactant for use in the present invention is preferably, for example, a compound represented by the following formula (33):

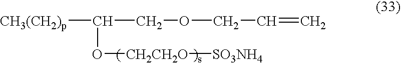

[wherein p is 9 or 11, q is an integer of 2 to 20, A is a group represented by —SO₃M³, and M³ is an alkali metal, an ammonium salt or an alkanolamine]. The anionic polymerizable surfactant represented by formula (33) is preferably a compound shown below.

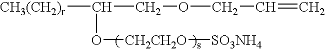

[wherein r is 9 or 11, and s is 5 or 10].

As regards the compounds (anionic polymerizable surfactants) represented by formula (33) and the formula of [Chem. 9] above, a commercially available product may also be used. Examples of the commercially available product include AQUALON KH Series (AQUALON KH-5 and AQUALON KH-10) (all are trade names) produced by Dai-ichi Kogyo Seiyaku Co., Ltd. AQUALON KH-5 is a mixture of a compound where in the compound represented by formula (33), r is 9 and s is 5, and a compound where r is 11 and s is 5, and AQUALON KH-10 is a mixture of a compound where in the compound represented by the formula of [Chem. 9] above, r is 9 and s is 10, and a compound where r is 11 and s is 10.

Furthermore, the anionic polymerizable surfactant for use in the present invention is preferably a compound represented by the following formula (34):

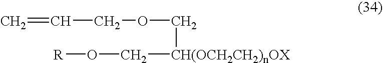

[wherein R is an alkyl group having a carbon number of 8 to 15, n is an integer of 2 to 20, X is a group represented by —SO₃B, and B is an alkali metal, an ammonium salt or an alkanolamine].

As regards the compound (anionic polymerizable surfactant) represented by formula (34), a commercially available product may also be used. Examples of the commercially available product include ADEKA REARSOPE SR Series (ADEKA REARSOPE SR-10, SR-20 and SR-1025) (all trade names) produced by Asahi Denka Co., Ltd. ADEKA REARSOPE SR Series is a compound where in formula (34), B is NH₄. SR-10 is a compound where n=10, and SR-20 is a compound where n=20.

As for the anionic polymerizable surfactant for use in the present invention, a compound represented by the following formula (A) may also be used.

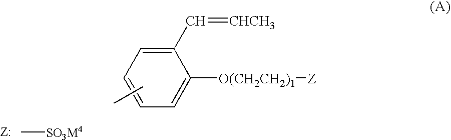

[wherein R⁴ represents a hydrogen atom or a hydrocarbon group having a carbon number of 1 to 12, l represents a number of 2 to 20, and M⁴ represents an alkali metal, an ammonium salt or an alkanolamine].

As regards the compound (anionic polymerizable surfactant) represented by formula (A), a commercially available product may also be used. Examples of the commercially available product include AQUALON HS Series (AQUALON HS-10, HS-20 and HS-1025) (all are trade names) produced by Dai-ichi Kogyo Seiyaku Co., Ltd.

Also, the anionic polymerizable surfactant for use in the present invention includes, for example, a sodium alkylallylsulfosuccinate represented by the following formula (35):

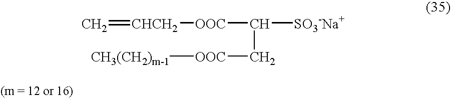

As regards the compound (anionic polymerizable surfactant) represented by formula (35), a commercially available product may also be used. Examples of the commercially available product include ELEMINOL JS-2 produced by Sanyo Chemical Industries, Ltd., and this is a compound where in formula (35), m=12.

Furthermore, the anionic polymerizable surfactant for use in the present invention includes, for example, a sodium methacryloyloxy polyoxyalkylene sulfate represented by the following formula (36). In formula (36), n is a number of 1 to 20.

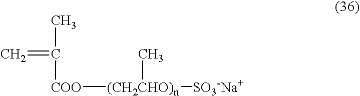

As regards the compound (anionic polymerizable surfactant) represented by formula (36), a commercially available product may also be used. Examples of the commercially available product include ELEMINOL RS-30 produced by Sanyo Chemical Industries, Ltd., and this is a compound where in formula (36), n=9.

Also, as for the anionic polymerizable surfactant for use in the present invention, for example, a compound represented by the following formula (37) may be used.

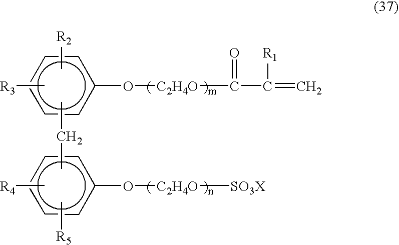

[wherein R₁ represents a hydrogen atom or a methyl group, R₂ and R₄ may be the same or different and each represents a hydrogen atom or an alkyl group, R₃ and R₅ may be the same or different and each represents a hydrogen atom, an alkyl group, a benzyl group or a styrene group, X represents an alkali metal atom, an alkaline earth metal atom, ammonium or an amine cation, m represents 0 or an integer of 1 or more, and n represents an integer of 1 or more].

As regards the compound (anionic polymerizable surfactant) represented by formula (37), a commercially available product may also be used. Examples of the commercially available product include Antox MS-60 produced by Nippon Nyukazai Co., Ltd., and this comes under a compound where in formula (37), R₁ is a methyl group, R₂, R₃, R₄ and R₅ each is a hydrogen atom or an alkyl group, m and n each is a positive integer, and X is ammonium.

One of these anionic polymerizable surfactants may be used alone or two or more species thereof may be used as a mixture.

### [Ionic Polymerizable Surfactant B]

The ionic polymerizable surfactant B is a polymerization component of the polymer which is the main component of the wall material coating the core substance, and has an ionic group with an electric charge the same as or opposite the electric charge on the core substance surface, a hydrophobic group and a polymerizable group. As for the ionic group, hydrophobic group and polymerizable group, the same groups as those describe above in the paragraph of “Ionic Polymerizable Surfactant A” may be used. Also, as for the ionic polymerizable surfactant B, the same compounds as those of the cationic polymerizable surfactant and anionic polymerizable surfactant described in the paragraph of “Ionic Polymerizable Surfactant A” may be used.

### [Ionic Monomer]

The ionic monomer is a polymerization component of the polymer which is the main component of the wall material coating the core substance, and has an ionic group with an electric charge opposite the electric charge on the core substance surface, a hydrophobic group and a polymerizable group.

The hydrophobic group is preferably one species or two or more species selected from the group consisting of an alkyl group having a carbon number of 1 to 7 and an aryl group such as phenyl group and phenylene group, and may have both an alkyl group and an aryl group in the molecule.

As for the polymerizable group, the same groups as those described above in the paragraph of “Ionic Polymerizable Surfactant A” may be used.

The ionic group includes a cationic group and an anionic group. The ionic monomer having a cationic group as the ionic group is called “a cationic water-soluble monomer”, and the ionic monomer having an anionic group as the ionic group is called “an anionic water-soluble monomer”. In the present invention, either a cationic monomer or an anionic monomer may be used as the ionic monomer, and an appropriate ionic monomer may be selected according to usage of the encapsulated material.

The cationic group (ionic group) is preferably a cationic group selected from the group consisting of a primary ammonium cation, a secondary ammonium cation, a tertiary ammonium cation and a quaternary ammonium cation. Examples of the primary ammonium cation include a monoalkylammonium cation (RNH₃⁺); examples of the secondary ammonium cation include a dialkylammonium cation (R₂NH₂⁺); examples of the tertiary ammonium cation include a trialkylammonium cation (R₃NH⁺); and examples of the quaternary ammonium cation include (R₄N⁺). Here, R is a hydrophobic group, and examples thereof include those described below. Examples of the counter anion of the above-described cationic group include Cl⁻, Br⁻, I⁻, CH₃OSO₃⁻ and C₂H₅OSO₃⁻.

Examples of the anionic group (ionic group) include a sulfonic acid group (—SO₃⁻), a sulfinic acid group (—SO₂⁻), a sulfuric ester group (—OSO₃⁻), a carboxyl group (—COO⁻), a phosphoric acid group (═O₂PO(O⁻), —OPO(O⁻)₂), a phosphorous acid group (═O₂PO⁻, —OP(O⁻)₂), a phosphonic acid group (—PO₂(O⁻), —PO(O⁻)₂), a sulfinic ester group (—OSO₂⁻), and a phosphoric ester group, and these are used in the form of a salt. Specific preferred examples of the salt include a sulfonate (—SO₃M), a sulfinate (—SO₂M), a sulfuric ester salt (—OSO₃M), a carboxylate (—COOM), a phosphate (═O₂PO(OM), —OPO(OM)₂), a phosphite (═O₂POM, —OP(OM)₂), a phosphate (—PO₂(OM), —PO(OM)₂), a sulfinic ester salt (—OSO₂M) and a phosphoric ester salt. M is hydrogen, an alkali metal, an alkaline earth metal, NH₄, amine, ethanolamine or the like.

Specific preferred examples of the cationic water-soluble monomer for use in the present invention include dimethylaminoethyl methacrylate methylchloride salt, dimethylaminoethyl methacrylate benzylchloride salt, methacryloyloxyethyl trimethylammonium chloride salt, diallyldimethylammonium chloride and 2-hydroxy-3-methacryloxypropyl trimethylammonium chloride. As regards the cationic water-soluble monomer, a commercially available product may also be used, and examples thereof include ACRYESTER DMC (Mitsubishi Rayon Co., Ltd.), ACRYESTER DML60 (Mitsubishi Rayon Co., Ltd.) and C-1615 (Dai-ichi Kogyo Seiyaku Co., Ltd.). One of these cationic water-soluble monomers may be used alone, or two or more species thereof may be used as a mixture.

As for specific preferred examples of the anionic water-soluble monomer which can be used in the present invention, examples of the monomer having a carboxyl group include an acrylic acid, a methacrylic acid, a crotonic acid, a propylacrylic acid, an isopropylacrylic acid, a 2-acryloyloxyethylsuccinic acid, a 2-acryloyloxyethylphthalic acid, a 2-methacryloyloxyethylsuccinic acid, a 2-methacryloyloxyethylphthalic acid, an itaconic acid, a fumaric acid and a maleic acid. Among these, an acrylic acid and a methacrylic acid are preferred. Examples of the monomer having a sulfonic acid group include a 4-styrenesulfonic acid and a salt thereof, a vinylsulfonic acid and a salt thereof, a sulfoethyl acrylate and a salt thereof, a sulfoethyl methacrylate and a salt thereof, a sulfoalkyl acrylate and a salt thereof, a sulfoalkyl methacrylate and a salt thereof, a sulfopropyl acrylate and a salt thereof, a sulfopropyl methacrylate and a salt thereof, a sulfoaryl acrylate and a salt thereof, a sulfoaryl methacrylate and a salt thereof, a butylacrylamidosulfonic acid and a salt thereof, and a 2-acrylamido-2-methylpropanesulfonic acid and a salt thereof. Examples of the monomer having a phosphonic group include a phosphoric acid group-containing (meth)acrylate such as phosphoethyl methacrylate. One of these anionic water-soluble monomers may be used alone, or two or more species thereof may be used as a mixture.

### [Hydrophobic Monomer]

Examples of the hydrophobic monomer for use in the present invention include those having at least a hydrophobic group and a polymerizable group in its structure, where the hydrophobic group is selected from the group consisting of an aliphatic hydrocarbon group, an alicyclic hydrocarbon group and an aromatic hydrocarbon, group. Examples of the aliphatic hydrocarbon group include a methyl group, an ethyl group and a propyl group; examples of the alicyclic hydrocarbon group include a cyclohexyl group, a dicyclopentenyl group, a dicyclopentanyl group and an isobornyl group; and examples of the aromatic hydrocarbon group include a benzyl group, a phenyl group and a naphthyl group.

As for the polymerizable group of the hydrophobic monomer, the same as those described above in the paragraph of “Ionic Polymerizable Surfactant A” may be used.

Specific examples of the hydrophobic monomer include styrene derivatives such as styrene, methylstyrene, vinyltoluene, dimethylstyrene, chlorostyrene, dichlorostyrene, tert-butylstyrene, bromostyrene and p-chloromethylstyrene; monofunctional acrylic esters such as methyl acrylate, ethyl acrylate, isopropyl acrylate, n-butyl acrylate, butoxyethyl acrylate, isobutyl acrylate, n-amyl acrylate, isoamyl acrylate, n-hexyl acrylate, octyl acrylate, decyl acrylate, dodecyl acrylate, octadecyl acrylate, benzyl acrylate, phenyl acrylate, phenoxyethyl acrylate, cyclohexyl acrylate, dicyclopentanyl acrylate, dicyclopentenyl acrylate, dicyclopentenyloxyethyl acrylate, tetrahydrofurfuryl acrylate, isobornyl acrylate, isoamyl acrylate, lauryl acrylate, stearyl acrylate, behenyl acrylate, ethoxydiethylene glycol acrylate, methoxytriethylene glycol acrylate, methoxydipropylene glycol acrylate, phenoxypolyethylene glycol acrylate, nonylphenol EO adduct acrylate, isooctyl acrylate, isomyristyl acrylate, isostearyl acrylate, 2-ethylhexyl diglycol acrylate and octoxypolyethylene glycol polypropylene glycol monoacrylate; monofunctional methacrylic esters such as methyl methacrylate, ethyl methacrylate, isopropyl methacrylate, n-butyl methacrylate, i-butyl methacrylate, tert-butyl methacrylate, n-amyl methacrylate, isoamyl methacrylate, n-hexyl methacrylate, 2-ethylhexyl methacrylate, lauryl methacrylate, tridecyl methacrylate, stearyl methacrylate, isodecyl methacrylate, octyl methacrylate, decyl methacrylate, dodecyl methacrylate, octadecyl methacrylate, methoxydiethylene glycol methacrylate, polypropylene glycol monomethacrylate, benzyl methacrylate, phenyl methacrylate, phenoxyethyl methacrylate, cyclohexyl methacrylate, tetrahydrofurfuryl methacrylate, tert-butylcyclohexyl methacrylate, behenyl methacrylate, dicyclopentanyl methacrylate, dicyclopentenyl methacrylate, dicyclopentenyloxyethyl methacrylate, butoxymethyl methacrylate, isobornyl methacrylate and octoxypolyethylene glycol polypropylene glycol monomethacrylate; allyl compounds such as allylbenzene, allyl-3-cyclohexane propionate, 1-allyl-3,4-dimethoxybenzene, allyl phenoxyacetate, allyl phenylacetate, allylcyclohexane and allyl polyvalent carboxylate; unsaturated esters of fumaric acid, maleic acid, itaconic acid or the like; and radical polymerizable group-containing monomers such as N-substituted maleimide and cyclic olefin. One of these hydrophobic monomers may be used alone, or two or more species thereof may be used in combination.

### [Nonionic Polymerizable Surfactant]

The nonionic polymerizable surfactant for use in the present invention comprises: a nonionic group selected from the group consisting of a linear alkyl group having a carbon number of 8 to 16, a branched alkyl group having a carbon number of 8 to 16, an alkylbenzene (alkylphenyl group) or alkylnaphthalene (alkylnaphthyl group) having both an alkyl group and an aryl group in the molecule, and a polypropylene oxide group; a hydrophobic group such as hydroxyl group, polyoxyethylene group and polyglycerin group; and a polymerizable group. As regards the polymerizable group, the same as those described above in the paragraph of “Ionic Polymerizable Surfactant A” may be used.

As for the nonionic polymerizable surfactant for use in the present invention, a compound represented by the following formula (100) may be used.

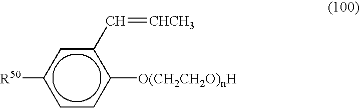

[wherein R⁵⁰ represents a hydrogen atom or a hydrocarbon group having a carbon number of 1 to 12, and n represents a number of 5 to 50].

As regards the compound (nonionic polymerizable surfactant) represented by formula (100), a commercially available product may also be used. Examples of the commercially available product include AQUALON RN Series (AQUALON RN-10, RN-20, RN-30, RN-50 and RN-2025) (all are trade names) produced by Dai-ichi Kogyo Seiyaku Co., Ltd. The following formula (101) indicates AQUALON RN-20.

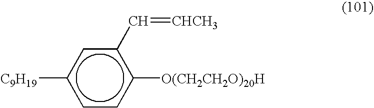

As for the nonionic polymerizable surfactant for use in the present invention, a compound represented by the following formula (103) may be used.

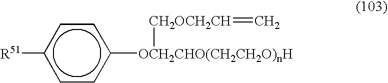

[wherein R⁵¹ represents a hydrogen atom or a hydrocarbon group having a carbon number of 1 to 12, and n represents a number of 5 to 50].

As regards the compound (nonionic polymerizable surfactant) represented by formula (103), a commercially available product may also be used. Examples of the commercially available product include NOIGEN Series (NOIGEN N-10, N-20, N-30 and N-50) (all are trade names) produced by Dai-ichi Kogyo Seiyaku Co., Ltd. The following formula (104) indicates NOIGEN N-20.

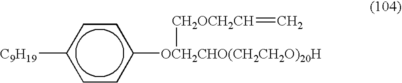

As for the nonionic polymerizable surfactant for use in the present invention, a compound represented by the following formula (105) may be used.

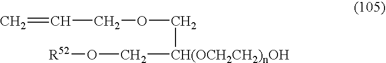

[wherein R⁵² is an alkyl group having a carbon number of 8 to 15, and n is an integer of 5 to 50].

As regards the compound (nonionic polymerizable surfactant) represented by formula (105), a commercially available product may also be used. Examples of the commercially available product include ADEKA REARSOPE ER Series (ADEKA REARSOPE ER-10, ER-20, ER-30 and ER-40) (all trade names) produced by Asahi Denka Co., Ltd. ER-10 is a compound where n=10, ER-20 is a compound where n=20, ER-30 is a compound where n=30, and ER-40 is a compound where n=40.

As for the nonionic polymerizable surfactant for use in the present invention, a compound represented by the following formula (106) may be used.

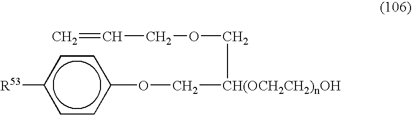

[wherein R⁵³ represents a hydrogen atom or a hydrocarbon group having a carbon number of 1 to 12, and n is a number of 5 to 50].

As regards the compound (nonionic polymerizable surfactant) represented by formula (106), a commercially available product may also be used. Examples of the commercially available product include ADEKA REARSOPE NE Series (ADEKA REARSOPE NE-5, NE-10, NE-20, NE-30 and NE-40) (all trade names) produced by Asahi Denka Co., Ltd. NE-5 is a compound where n=5, NE-10 is a compound where n=10, NE-20 is a compound where n=20, NE-30 is a compound where n=30, and NE-40 is a compound where n=40. The following formula (107) indicates ADEKA REARSOPE NE-10.

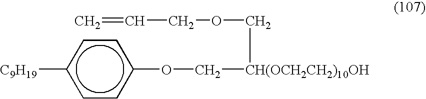

Examples of the nonionic polymerizable surfactant for use in the present invention include poly(ethylene glycol-propylene glycol) monomethacrylate (trade name: BLEMMER 50PEP-300<produced by NOF Corp.>, formula (108)), polyethylene glycol-polypropylene glycol monomethacrylate (trade name: BLEMMER 70PEP-350B<produced by NOF Corp.>, formula (109)), polyethylene glycol-polypropylene glycol monoacrylate (trade name: BLEMMER AEP Series <produced by NOF Corp.>), poly(ethylene glycol-tetramethylene glycol) monoacrylate (trade name: BLEMMER AET Series <produced by NOF Corp.>), poly(propylene glycol-tetramethylene glycol) monoacrylate (trade name: BLEMMER APT Series <produced by NOF Corp.>), lauroxy polyethylene glycol monomethacrylate (trade name: BLEMMER PLE-200<produced by NOF Corp.>, formula (110)), lauroxy polyethylene glycol monoacrylate (trade name: BLEMMER ALE-200 and ALE-800<produced by NOF Corp.>, formula (111)), stearoxy polyethylene glycol monomethacrylate (trade name: BLEMMER PSE-200, PSE-400 and PSE-1300<produced by NOF Corp.>, formula (112)), stearoxy polyethylene glycol-polypropylene glycol monoacrylate (trade name: BLEMMER ASEP Series <produced by NOF Corp.>, formula (113)), nonylphenoxy polyethylene glycol monoacrylate (trade name: BLEMMER ANE-300 and ANE-1300 <produced by NOF Corp.>, formula (114)), nonylphenoxy polyethylene glycol-polypropylene glycol monomethacrylate (trade name: BLEMMER PNEP Series <produced by NOF Corp.>, formula (115)), nonylphenoxy polypropylene glycol-polyethylene glycol monomethacrylate (trade name: BLEMMER PNPE Series <produced by NOF Corp.>, formula (116)), and nonylphenoxy poly(ethylene glycol-propylene glycol) monoacrylate (trade name: BLEMMER 43ANEP-500, 70ANEP-550 and 75ANEP-600<produced by NOF Corp.>).

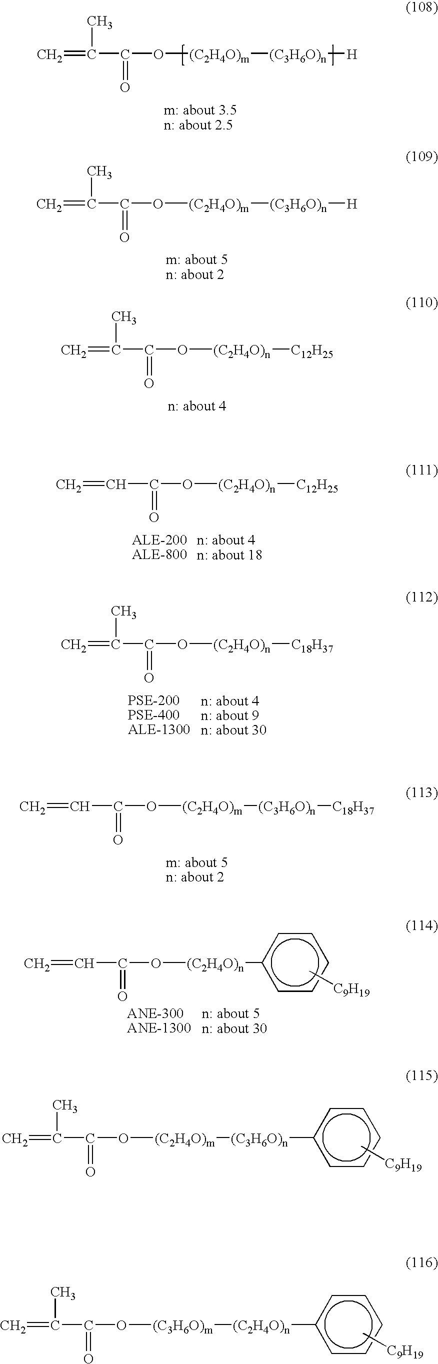

### [Other Polymerization Components]

As for the raw material of the wall material for use in the present invention, a polymerization component other than the polymerization components above (the ionic polymerizable surfactant A and/or ionic monomer, the hydrophobic monomer, the ionic polymerizable surfactant B, the nonionic polymerizable surfactant) may be used, and examples thereof include a crosslinking monomer.

By virtue of incorporating a repeating unit derived from a crosslinking monomer into the polymer which is the main component of the wall material, a crosslinked structure is formed in the polymer, and the solvent resistance (a property not easily allowing the solvent contained in the inkjet recording ink to intrude into the inside of the polymer coating the core substance) can be enhanced. If the solvent penetrates into the inside of the polymer coating the core substance, the polymer may undergo swelling, deformation or the like to cause, for example, disturbance of the state of anionic groups orienting toward the aqueous medium side of the encapsulated material, and the dispersion stability and the like may deteriorate. In such a case, when a crosslinked structure is formed in the polymer coating the core substance, the solvent resistance of the encapsulated material is enhanced and in the ink composition where a water-soluble organic solvent is present together, the dispersion stability of encapsulated material, the storage stability of ink composition, and the ejection stability of ink composition from the inkjet head can be more elevated. Also, when the hydrophobic monomer and the crosslinking monomer are copolymerized, the mechanical strength and heat resistance of the polymer as the main component of the wall material are elevated, and the shape retentivity of the wall material is enhanced.

The crosslinking monomer for use in the present invention includes those containing a compound having two or more unsaturated hydrocarbon groups of at least one species selected from a vinyl group, an allyl group, an acryloyl group, a methacryloyl group, a propenyl group, a vinylidene group and a vinylene group. Specific examples of the crosslinking monomer include ethylene glycol diacrylate, diethylene glycol diacrylate, triethylene glycol diacrylate, tetraethylene glycol diacrylate, polyethylene glycol diacrylate, allyl acrylate, bis(acryloxyethyl)hydroxyethyl isocyanurate, bis(acryloxyneopentyl glycol) adipate, 1,3-butylene glycol diacrylate, 1,6-hexanediol diacrylate, neopentyl glycol diacrylate, propylene glycol diacrylate, polypropylene glycol diacrylate, 2-hydroxy-1,3-diacryloxypropane, 2,2-bis[4-(acryloxy)phenyl]propane, 2,2-bis[4-(acryloxyethoxy)phenyl]propane, 2,2-bis[4-(acryloxyethoxy-diethoxy)phenyl]-propane, 2,2-bis[4-(acryloxyethoxy-polyethoxy)phenyl]-propane, hydroxypivalic acid neopentyl glycol diacrylate, 1,4-butanediol diacrylate, dicyclopentanyl diacrylate, dipentaerythritol hexaacrylate, dipentaerythritol monohydroxypentaacrylate, ditrimethylolpropane tetraacrylate, pentaerythritol triacrylate, tetrabromobisphenol A diacrylate, triglycerol diacrylate, trimethylolpropane triacrylate, tris(acryloxyethyl) isocyanurate, ethylene glycol dimethacrylate, diethylene glycol dimethacrylate, triethylene glycol dimethacrylate, tetraethylene glycol dimethacrylate, polyethylene glycol dimethacrylate, propylene glycol dimethacrylate, polypropylene glycol dimethacrylate, 1,3-butylene glycol dimethacrylate, 1,4-butanediol dimethacrylate, 1,6-hexanediol dimethacrylate, neopentyl glycol dimethacrylate, 2-hydroxy-1,3-dimethacryloxypropane, 2,2-bis[4-(methacryloxy)phenyl]propane, 2,2-bis[4-(methacryloxyethoxy)phenyl]propane, 2,2-bis[4-(methacryloxyethoxydiethoxy)phenyl]propane, 2,2-bis[4-(methacryloxyethoxypolyethoxy)phenyl]propane, tetrabromobisphenol A dimethacrylate, dicyclopentanyl dimethacrylate, dipentaerythritol hexamethacrylate, glycerol dimethacrylate, hydroxypivalic acid neopentyl glycol dimethacrylate, dipentaerythritol monohydroxypentamethacrylate, ditrimethylolpropane tetramethacrylate, pentaerythritol trimethacrylate, pentaerythritol tetramethacrylate, triglycerol dimethacrylate, trimethylolpropane trimethacrylate, tris(methacryloxyethyl) isocyanurate, allyl methacrylate, divinylbenzene, diallyl phthalate, diallyl terephthalate, diallyl isophthalate and diethylene glycol bisallylcarbonate. One of these crosslinking monomers may be used alone, or two or more species thereof may be used in combination.

As for the other polymerization component, a compound represented by the following formula (1) may be used.

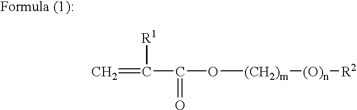

[wherein R¹ represents a hydrogen atom or a methyl group, R² represents a tert-butyl group, an alicyclic hydrocarbon group, an aromatic hydrocarbon group or a heterocyclic group, m represents an integer of 0 to 3, and n represents an integer of 0 or 1].

In formula (1), examples of the alicyclic hydrocarbon group represented by R² include a cycloalkyl group, a cycloalkenyl group, an isobornyl group, a dicyclopentanyl group, a dicyclopentenyl group and an adamantane group, and examples of the heterocyclic group include a tetrahydrofuran group.

Specific examples of the compound represented by formula (1) are set forth below.

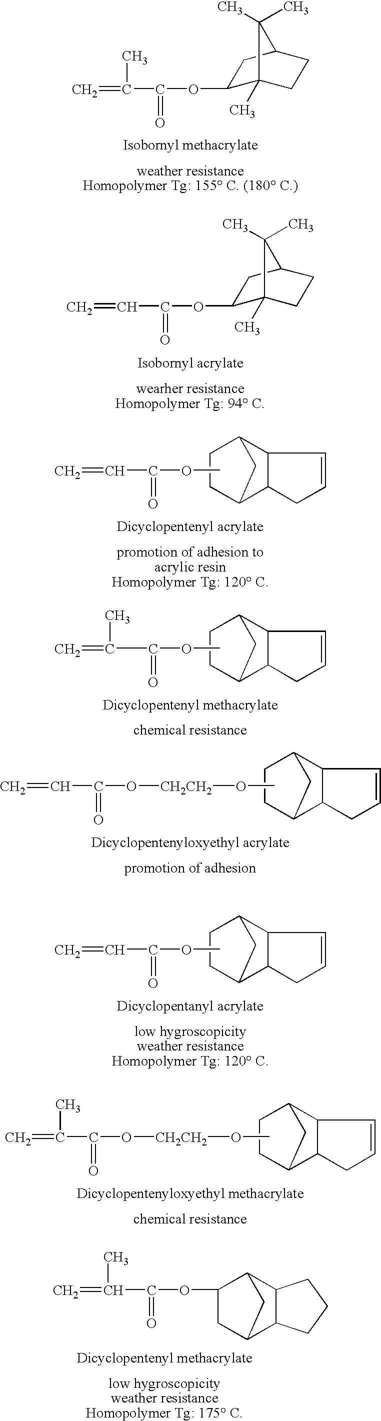

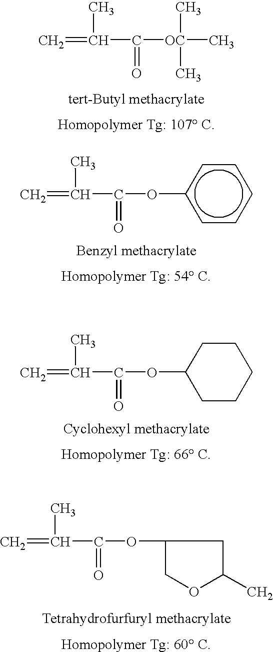

When the R² group which is a “bulky” group derived from the compound represented by formula (1) is incorporated into the polymer as the main component of the wall material of the encapsulated material according to the present invention, this enables to decrease the deflection of the polymer molecule, that is, the mobility of the molecule, and thereby enhance the mechanical strength and heat resistance of the polymer. Therefore, the ink composition containing the encapsulated material of this embodiment having a wall material mainly comprising the polymer above can provide a printed matter excellent in the scratch resistance and durability. Furthermore, by virtue of causing the R² group which is a “bulky” group to exist in the polymer constituting the wall material, the organic solvent in the ink composition can be prevented from penetrating into the polymer and in turn, the encapsulated material can have excellent solvent resistance. As a result, the dispersibility of the color material particle in the inkjet recording ink composition where a water-soluble organic solvent is present together, as well as the storage stability of the ink composition and the ejection property of the ink composition from the inkjet head can be enhanced.

Here, the polymer having “a repeating structural unit derived from the crosslinking monomer” or the polymer having “a repeating structural unit derived from the compound represented by formula (1) has a high glass transition temperature (Tg) and is advantageous in that the mechanical strength, heat resistance and solvent resistance are excellent.

However, due to insufficient plasticity of the polymer, the encapsulated material having a wall material containing such a polymer, when used as a component of an ink composition, is liable to hardly adhere to a recording medium, as a result, the fixing property of the encapsulated material to a recording medium and the scratch resistance may decrease.

On the other hand, the polymer having a repeating structural unit derived from a monomer having a long-chain alkyl group out of the hydrophobic monomers has flexibility. Accordingly, when the ratio of the “repeating structural unit derived from the crosslinking monomer” and/or the “repeating structural unit derived from the compound (monomer) represented by formula (1)” to the “repeating structural unit derived from the monomer having a long-chain alkyl group” is appropriately adjusted, a wall material polymer having high mechanical strength and excellent solvent resistance can be obtained without impairing the plasticity preferred as the wall material. The ink composition containing an encapsulated material having a wall material comprising such a polymer is excellent in the dispersion stability, long-term storage stability and ejection stability from an inkjet head, even when a water-soluble organic solvent is contained in the ink composition. Also, the ink composition containing the encapsulated material of this embodiment is assured of good fixing property of the encapsulated material to a recording medium such as paper and inkjet recording special paper and can provide a printed image excellent in the scratch resistance, durability and solvent resistance.

### [Polymerization Initiator]

As for the polymerization initiator for use in the present invention, a known polymerization initiator may be used. Particularly, use of a radical polymerization initiator is preferred. The polymerization initiator may be water-soluble or oil-soluble, but a water-soluble polymerization initiator is preferred, and examples thereof include potassium persulfate, ammonium persulfate, sodium persulfate, 2,2-azobis-(2-methylpropionamidine) dihydrochloride and 4,4-azobis-(4-cyanovaleric acid). Also, a redox-type initiator combining potassium persulfate, ammonium persulfate, sodium persulfate or the like with sodium sulfite, sodium hyposulfite, ferrous sulfate or the like may be used.

### [Other Components]

As for the raw material constituting the encapsulated material of the present invention, other than those described above, for example, an ultraviolet absorbent, a light stabilizer, an antioxidant, a flame retardant, a plasticizer and wax may be used.

The encapsulated material produced by the production method of the present invention is described below.

### [Particle Size, etc. of Encapsulated Material]

The particle size of the encapsulated material of the present invention may be appropriately adjusted according to usage of the encapsulated material and is not particularly limited. In particular, when the encapsulated material is used as a color material of the inkjet recording ink, the particle size is, in terms of the volume average particle size, preferably 400 nm or less, more preferably from 10 to 200 nm. The particle size of the encapsulated material can be controlled by the addition such that the concentration of the ionic polymerizable surfactant B in the solvent of the reaction system becomes the critical micell concentration as described above, and by the amount added of the hydrophobic monomer determined from the volume ratio of the hydrophobic monomer to the core substance and the average particle size of the core substance.

The encapsulated material of the present invention preferably has an aspect ratio (fineness ratio) of 1.0 to 1.3 and a Zingg index of 1.0 to 1.3 (more preferably from 1.0 to 1.2). If the Zingg index exceeds 1.3, the shape of the encapsulated material becomes flatter and the isotropy decreases. The method for adjusting the aspect ratio and the Zingg index to those ranges is not particularly limited, but the encapsulated material obtained by the production method of the present invention can easily satisfy these conditions. In the case of using the encapsulated material as a color material of the inkjet recording ink, when the aspect ratio and Zingg index each is in the range above, the encapsulated material exhibits high dispersibility in the ink solvent and excellent dispersion stability. Also, the ejection stability is excellent and there may be easily obtained high OD value on plain paper or high gloss and high image clarity on gloss film.

In the production method of an encapsulated material except for the present invention, such as acid precipitation method or phase inversion emulsification method, the encapsulated material can hardly have an aspect ratio and a Zingg index within the above-described ranges.

On the other hand, the encapsulated material obtained by the production method of the present invention has an aspect ratio and a Zingg index each in the range above and becomes like a true sphere and therefore, when used as an ink component, the ink readily exhibits Newtonian flow behavior and excellent ejection stability. Also, by virtue of the true spherical shape, when the ink is landed on a recording medium such as paper, the encapsulated material is arranged on the recording medium at a high density, and this enables to express printing density and color formation with high efficiency. Furthermore, by virtue of the true spherical shape, the dispersibility and dispersion stability are also excellent.

The encapsulated material of the present invention can be made to have film-forming property, wall material strength, chemical resistance, water resistance, light fastness, weather resistance, optical property and other physical and chemical properties suitable for the usage of the encapsulated material by appropriately controlling the composition, structure and the like of the polymer which is the main component of the wall material.

Particularly, when the encapsulated material is used as a color material of the inkjet recording ink, the fixing property of color material and the scratch resistance and gloss of printed part can be controlled by the glass transition temperature (Tg) of the polymer (copolymer) which is the main component of the wall material.

In general, when the temperature of a polymer solid, particularly, an amorphous polymer solid, is elevated from low temperature to high temperature, there arises a phenomenon that a state (vitreous state) where a very large force is required for slight deformation abruptly changes into a state where large deformation occurs with a small force. The temperature at which this phenomenon arises is called a glass transition temperature (or a glass transition point). In a differential thermal curve obtained by measuring the temperature rise by means of a differential scanning calorimeter, the temperature at an intersection of a tangential line drawn from the bottom of heat absorption peak to the initiation point of heat absorption and a base line is generally taken as the glass transition temperature (Tg as used in the present invention is in accordance with this definition). Furthermore, it is known that other physical properties such as elastic modulus, specific heat and refractive index also abruptly change at the glass transition temperature and that the glass transition temperature is also determined by measuring these physical properties. Other than these, the glass transition temperature can be calculated according to the following Fox formula from the weight fraction of a monomer used for the synthesis of a copolymer and the glass transition point of a homopolymer obtained by homopolymerizing the monomer (in the present invention, the glass transition temperature obtained according to the Fox formula is used).

$$\frac{1}{{Tg}_{[ p ]}} = {\sum }_{i}^{ } ( \frac{{x}_{i}}{{Tg}_{[ h p ] i}} ) \qquad ( Fox formula )$$

(wherein Tg_{[p]} is the glass transition temperature of the obtained polymer, i is the number affixed every different kinds of monomers, Tg_{[hp]i} is the glass transition temperature of the homopolymer of monomer i used for the polymerization, and xᵢ is the weight fraction of monomer i based on the total weight of monomers polymerized).

In other words, when the temperature in the environment where the encapsulated material is placed is higher than the glass transition temperature of the copolymer constituting the wall material of the encapsulated material, the copolymer enters a state where large deformation occurs with a small force, and when the temperature further reaches the melting point, the copolymer melts. At this time, when other encapsulated materials are present in the vicinity, the encapsulated material are fused with each other to form a film. Even when the ambient temperature does not reach the melting point, in the case where the encapsulated materials are put into contact with one another by a strong force, if the condition allowing the copolymer molecules coating respective encapsulated materials to intertwine with each other is satisfied, the copolymers coating encapsulated materials are sometimes fused each other.

In the case where printing on a recording medium such as plain paper or inkjet recording special paper is performed with an ink using the encapsulated material as a color material, in order to more successfully bring about film formation of the encapsulated material at room temperature and obtain good results in terms of the fixing property of color material and the scratch resistance and gloss of printed part, Tg of the polymer as the main component of the wall material is preferably 30° C. or less, more preferably 15° C. or less, still more preferably 10° C. or less. Accordingly, in the case of using the encapsulated material for the inkjet ink, the polymer (copolymer) constituting the wall material is preferably designed to have a glass transition temperature of 30° C. or less, more preferably 15° C. or less, still more preferably 10° C. or less. However, if the glass transition temperature is less than −20° C., the solvent resistance tends to decrease and therefore, careful design is demanded.

### EXAMPLES

The present invention will be illustrated in greater detail below with reference to the following Examples, but the invention should not be construed as being limited thereto.

### (Production of Magenta Pigment P1 Having Anionic Group on Surface)

After mixing 20 g of an isoindolinone pigment (C.I. Pigment Red 122) with 500 g of quinoline, the mixture was dispersed for 2 hours in Eiger Motor Mill M250 (manufactured by Eiger Japan Co., Ltd.) under the conditions of a bead loading of 70% and a rotation number of 5,000 rpm. A mixed solution of the dispersed pigment paste and a solvent was transferred to an evaporator and heated to 120° C. under reduced pressure of 30 mmHg or less, thereby distilling off the water contained in the system as much as possible, and the temperature was then controlled to 160° C. Subsequently, 20 g of a sulfonated pyridine complex was added and allowed to react for 8 hours. After the completion of reaction, the reaction product was washed several times with excess quinoline, then poured into water and further filtered to obtain Magenta Pigment P1 having an anionic group (sulfonic acid group) on its surface. The sulfur content of Magenta Pigment P1 obtained was determined by a flask combustion method and found to be 0.36%, and the amount of the anionic group (sulfonic acid group) introduced into the pigment surface, determined from the sulfur content above, was 1.16×10⁻⁴ mol/g (the molar number of anionic polymerizable surfactant per g of pigment).

### (Production of Cyan Pigment P2 Having Adsorbed to the Surface Thereof Anionic Polymerizable Surfactant)

After mixing 20 g of a copper phthalocyanine pigment (C.I. Pigment Blue 15:1) with 10 g of an anionic polymerizable surfactant, AQUALON KH-10 (produced by Dai-ichi Kogyo Seiyaku Co., Ltd.), and ion exchanged water, the mixture was dispersed for 2 hours in Eiger Motor Mill M250 (manufactured by Eiger Japan Co., Ltd.) under the conditions of a bead loading of 70% and a rotation number of 5,000 rpm, and unadsorbed anionic polymerizable surfactant KH-10 was removed by ultrafiltration. In this washing by ultrafiltration, the change in the absorption spectrum of permeated water was traced by a spectrophotometer and the treatment was ended at the point where the absorption became constant. In this way, the objective Cyan Pigment P2 having adsorbed to the surface thereof the anionic polymerizable surfactant KH-10 was obtained in the form of a liquid dispersion. The solid content concentration of the obtained liquid dispersion was 11.0%. Also, the content of the anionic polymerizable surfactant KH-10 in the liquid dispersion was determined by thermogravimetric analysis and found to be 22.3% based on the pigment. The sulfur content as determined by the flask combustion method was 0.64%, and the amount of the anionic polymerizable surfactant KH-10 in the liquid dispersion (regarded as the amount of the anionic polymerizable surfactant adsorbed to the pigment), determined from the sulfur content above, was 2.0×10⁻⁴ mol/g (the molar number of the anionic polymerizable surfactant per g of the pigment). Furthermore, the volume average particle size was measured by a laser Doppler system particle size distribution analyzer, Microtrac UPA150, manufactured by Leads & Northlop Co. and found to be 72 nm.

(Production of Encapsulated Material Liquid Dispersions M1 to M8, H1 and H2) Encapsulated Material Liquid Dispersions M1 to M8, H1 and H2 were produced as follows by using Magenta Pigment P1 or Cyan Pigment P2 as the core substance. Encapsulated Material Liquid Dispersions M1 to M8 are Examples of the present invention and Encapsulated Liquid Dispersions H1 and H2 are Comparative Examples.

### <Production of Encapsulated Liquid Dispersion M1>

Magenta Pigment P1 (100 g) was dispersed in 900 g of ion exchanged water, and the volume average particle size of the resulting dispersion was measured by a laser Doppler system particle size distribution analyzer, Microtrac UPA150, manufactured by Leads & Northlop Co. and found to be 95 nm. Subsequently, 2.41 g of dimethylaminoethyl methacrylate methylchloride salt was added to the aqueous liquid dispersion of Magenta Pigment P1 and mixed with stirring for 30 minutes, and the mixture was then irradiated with an ultrasonic wave for 30 minutes. A mixture obtained by mixing 97.5 g of benzyl methacrylate, 37.5 g of isobornyl methacrylate and 15.0 g of lauryl methacrylate was added thereto and mixed with stirring, and 0.98 g of Anionic Polymerizable Surfactant SR-10 (produced by Asahi Denka Co., Ltd.) dissolved in 100 ml of ion exchanged water was further added to the mixture above and mixed with stirring for 1 hour. Here, the amount of Anionic Polymerizable Surfactant SR-10 (produced by Asahi Denka Co., Ltd.) added was adjusted such that the concentration of SR-10 in the final mixed solution (mixed solution immediately before the addition of a polymerization initiator) became the critical micell concentration of SR-10 for the water amount (weight of ion exchanged water) in the final mixed solution. The critical micell concentration of SR-10 is 0.7 g/liter. Furthermore, 393 ml of ion exchanged water was added and mixed with stirring for 1 hour. The mixture obtained was charged into a reaction vessel provided with a reflux tube, a nitrogen inlet tube, a dropping tube, a stirring device and a temperature regulator, the temperature was elevated to 80° C. over 40 minutes while flowing nitrogen, 3.0 g of potassium persulfate dissolved in 600 ml of ion exchanged water was added dropwise over 1 hour, the reaction was further allowed to proceed for 4 hours, and the temperature was then lowered to stop the reaction.

After the completion of polymerization, the pH was adjusted to 8 with an aqueous 1 mol/liter potassium hydroxide solution, and coarse particles were removed through a prefilter. The residue was ultrafiltered by a cross-flow process in an ultrafiltration apparatus to obtain the objective Encapsulated Material Liquid Dispersion M1. Incidentally, the glass transition temperature of the coat polymer was set to 58° C. by using the Fox formula.

### <Production of Encapsulated Material Liquid Dispersion M2>

Dimethylaminoethyl methacrylate methylchloride salt (0.62 g) was added to 136 g of Cyan Pigment P2 (in the form of a liquid dispersion) and mixed with stirring for 30 minutes, and the mixture was then irradiated with an ultrasonic wave for 30 minutes. A mixture obtained by mixing 4.57 g of benzyl methacrylate, 2.55 g of isobornyl methacrylate and 1.35 g of lauryl methacrylate was added thereto and mixed with stirring, and 0.38 g of Anionic Polymerizable Surfactant SR-10 (produced by Asahi Denka Co., Ltd.) dissolved in 100 ml of ion exchanged water was further added to the mixture above and mixed with stirring for 1 hour. Here, the amount of Anionic Polymerizable Surfactant SR-10 (produced by Asahi Denka Co., Ltd.) added was adjusted such that the concentration of SR-10 in the final mixed solution (mixed solution immediately before the addition of a polymerization initiator) became the critical micell concentration of SR-10 for the water amount (weight of ion exchanged water) in the final mixed solution. The critical micell concentration of SR-10 is 0.7 g/liter. Furthermore, 220 ml of ion exchanged water was added and mixed with stirring for 1 hour. The mixture obtained was charged into a reaction vessel provided with a reflux tube, a nitrogen inlet tube, a dropping tube, a stirring device and a temperature regulator, the temperature was elevated to 80° C. over 40 minutes while flowing nitrogen, 0.24 g of potassium persulfate dissolved in 100 ml of ion exchanged water was added dropwise over 1 hour, the reaction was further allowed to proceed for 4 hours, and the temperature was then lowered to stop the reaction.

After the completion of polymerization, the pH was adjusted to 8 with an aqueous 1 mol/liter potassium hydroxide solution, and coarse particles were removed through a prefilter. The residue was ultrafiltered by a cross-flow process in an ultrafiltration apparatus and through a concentrating operation, the objective Encapsulated Material Liquid Dispersion M2 having a pigment concentration of 10 wt % was obtained. Incidentally, the glass transition temperature of the coat polymer was set to 52° C. by using the Fox formula.

### <Production of Encapsulated Material Liquid Dispersion M3>

Dimethylaminoethyl methacrylate methylchloride salt (0.62 g) was added to 136 g of Cyan Pigment P2 (in the form of a liquid dispersion) and mixed with stirring for 30 minutes, and the mixture was then irradiated with an ultrasonic wave for 30 minutes. A mixture obtained by mixing 6.86 g of benzyl methacrylate, 3.82 g of isobornyl methacrylate and 2.02 g of lauryl methacrylate was added thereto and mixed with stirring, and 0.44 g of Anionic Polymerizable Surfactant SR-10 (produced by Asahi Denka Co., Ltd.) dissolved in 100 ml of ion exchanged water was further added to the mixture above and mixed with stirring for 1 hour. Here, the amount of Anionic Polymerizable Surfactant SR-10 (produced by Asahi Denka Co., Ltd.) added was adjusted such that the concentration of SR-10 in the final mixed solution (mixed solution immediately before the addition of a polymerization initiator) became the critical micell concentration of SR-10 for the water amount (weight of ion exchanged water) in the final mixed solution. The critical micell concentration of SR-10 is 0.7 g/liter. Furthermore, 310 ml of ion exchanged water was added and mixed with stirring for 1 hour. The mixture obtained was charged into a reaction vessel provided with a reflux tube, a nitrogen inlet tube, a dropping tube, a stirring device and a temperature regulator, the temperature was elevated to 80° C. over 40 minutes while flowing nitrogen, 0.32 g of potassium persulfate dissolved in 100 ml of ion exchanged water was added dropwise over 1 hour, the reaction was further allowed to proceed for 4 hours, and the temperature was then lowered to stop the reaction.

After the completion of polymerization, the pH was adjusted to 8 with an aqueous 1 mol/liter potassium hydroxide solution, and coarse particles were removed through a prefilter. The residue was ultrafiltered by a cross-flow process in an ultrafiltration apparatus and through a concentrating operation, the objective Encapsulated Material Liquid Dispersion M3 having a pigment concentration of 10 wt % was obtained. Incidentally, the glass transition temperature of the coat polymer was set to 52° C. by using the Fox formula.

### <Production of Encapsulated Material Liquid Dispersion M4>

Dimethylaminoethyl methacrylate methylchloride salt (0.62 g) was added to 136 g of Cyan Pigment P2 (in the form of a liquid dispersion) and mixed with stirring for 30 minutes, and the mixture was then irradiated with an ultrasonic wave for 30 minutes. A mixture obtained by mixing 10.29 g of benzyl methacrylate, 5.73 g of isobornyl methacrylate and 3.03 g of lauryl methacrylate was added thereto and mixed with stirring, and 0.53 g of Anionic Polymerizable Surfactant SR-10 (produced by Asahi Denka Co., Ltd.) dissolved in 100 ml of ion exchanged water was further added to the mixture above and mixed with stirring for 1 hour. Here, the amount of Anionic Polymerizable Surfactant SR-10 (produced by Asahi Denka Co., Ltd.) added was adjusted such that the concentration of SR-10 in the final mixed solution (mixed solution immediately before the addition of a polymerization initiator) became the critical micell concentration of SR-10 for the water amount (weight of ion exchanged water) in the final mixed solution. The critical micell concentration of SR-10 is 0.7 g/liter. Furthermore, 430 ml of ion exchanged water was added and mixed with stirring for 1 hour. The mixture obtained was charged into a reaction vessel provided with a reflux tube, a nitrogen inlet tube, a dropping tube, a stirring device and a temperature regulator, the temperature was elevated to 80° C. over 40 minutes while flowing nitrogen, 0.45 g of potassium persulfate dissolved in 100 ml of ion exchanged water was added dropwise over 1 hour, the reaction was further allowed to proceed for 4 hours, and the temperature was then lowered to stop the reaction.

After the completion of polymerization, the pH was adjusted to 8 with an aqueous 1 mol/liter potassium hydroxide solution, and coarse particles were removed through a prefilter. The residue was ultrafiltered by a cross-flow process in an ultrafiltration apparatus and through a concentrating operation, the objective Encapsulated Material Liquid Dispersion M4 having a pigment concentration of 10 wt % was obtained. Incidentally, the glass transition temperature of the coat polymer was set to 52° C. by using the Fox formula.

### <Production of Encapsulated Material Liquid Dispersion M5>

Dimethylaminoethyl methacrylate methylchloride salt (0.62 g) was added to 136 g of Cyan Pigment P2 (in the form of a liquid dispersion) and mixed with stirring for 30 minutes, and the mixture was then irradiated with an ultrasonic wave for 30 minutes. A mixture obtained by mixing 16.01 g of benzyl methacrylate, 8.92 g of isobornyl methacrylate and 4.71 g of lauryl methacrylate was added thereto and mixed with stirring, and 0.68 g of Anionic Polymerizable Surfactant SR-10 (produced by Asahi Denka Co., Ltd.) dissolved in 100 ml of ion exchanged water was further added to the mixture above and mixed with stirring for 1 hour. Here, the amount of Anionic Polymerizable Surfactant SR-10 (produced by Asahi Denka Co., Ltd.) added was adjusted such that the concentration of SR-10 in the final mixed solution (mixed solution immediately before the addition of a polymerization initiator) became the critical micell concentration of SR-10 for the water amount (weight of ion exchanged water) in the final mixed solution. The critical micell concentration of SR-10 is 0.7 g/liter. Furthermore, 650 ml of ion exchanged water was added and mixed with stirring for 1 hour. The mixture obtained was charged into a reaction vessel provided with a reflux tube, a nitrogen inlet tube, a dropping tube, a stirring device and a temperature regulator, the temperature was elevated to 80° C. over 40 minutes while flowing nitrogen, 0.66 g of potassium persulfate dissolved in 100 ml of ion exchanged water was added dropwise over 1 hour, the reaction was further allowed to proceed for 4 hours, and the temperature was then lowered to stop the reaction.

After the completion of polymerization, the pH was adjusted to 8 with an aqueous 1 mol/liter potassium hydroxide solution, and coarse particles were removed through a prefilter. The residue was ultrafiltered by a cross-flow process in an ultrafiltration apparatus and through a concentrating operation, the objective Encapsulated Material Liquid Dispersion M5 having a pigment concentration of 10 wt % was obtained. Incidentally, the glass transition temperature of the coat polymer was set to 52° C. by using the Fox formula.

### <Production of Encapsulated Material Liquid Dispersion M6>

Dimethylaminoethyl methacrylate methylchloride salt (0.62 g) was added to 136 g of Cyan Pigment P2 (in the form of a liquid dispersion) and mixed with stirring for 30 minutes, and the mixture was then irradiated with an ultrasonic wave for 30 minutes. A mixture obtained by mixing 4.57 g of benzyl methacrylate, 2.55 g of isobornyl methacrylate, 1.35 g of lauryl methacrylate and 0.32 g of cetyl alcohol was added thereto and mixed with stirring, and 0.38 g of Anionic Polymerizable Surfactant SR-10 (produced by Asahi Denka Co., Ltd.) dissolved in 100 ml of ion exchanged water was further added to the mixture above and mixed with stirring for 1 hour. Here, the amount of Anionic Polymerizable Surfactant SR-10 (produced by Asahi Denka Co., Ltd.) added was adjusted such that the concentration of SR-10 in the final mixed solution (mixed solution immediately before the addition of a polymerization initiator) became the critical micell concentration of SR-10 for the water amount (weight of ion exchanged water) in the final mixed solution. The critical micell concentration of SR-10 is 0.7 g/liter. Furthermore, 220 ml of ion exchanged water was added and mixed with stirring for 1 hour. The mixture obtained was charged into a reaction vessel provided with a reflux tube, a nitrogen inlet tube, a dropping tube, a stirring device and a temperature regulator, the temperature was elevated to 80° C. over 40 minutes while flowing nitrogen, 0.24 g of potassium persulfate dissolved in 100 ml of ion exchanged water was added dropwise over 1 hour, the reaction was further allowed to proceed for 4 hours, and the temperature was then lowered to stop the reaction.

After the completion of polymerization, the pH was adjusted to 8 with an aqueous 1 mol/liter potassium hydroxide solution, and coarse particles were removed through a prefilter. The residue was ultrafiltered by a cross-flow process in an ultrafiltration apparatus to obtain the objective Encapsulated Material Liquid Dispersion M6.

### <Production of Encapsulated Material Liquid Dispersion M7>

Dimethylaminoethyl methacrylate methylchloride salt (0.62 g) was added to 136 g of Cyan Pigment P2 (in the form of a liquid dispersion) and mixed with stirring for 30 minutes, and the mixture was then irradiated with an ultrasonic wave for 30 minutes. A mixture obtained by mixing 4.57 g of benzyl methacrylate, 2.55 g of isobornyl methacrylate, 1.35 g of lauryl methacrylate and 5 g of hexanol was added thereto and mixed with stirring, and 0.38 g of Anionic Polymerizable Surfactant SR-10 (produced by Asahi Denka Co., Ltd.) dissolved in 100 ml of ion exchanged water was further added to the mixture above and mixed with stirring for 1 hour. Here, the amount of Anionic Polymerizable Surfactant SR-10 (produced by Asahi Denka Co., Ltd.) added was adjusted such that the concentration of SR-10 in the final mixed solution (mixed solution immediately before the addition of a polymerization initiator) became the critical micell concentration of SR-10 for the water amount (weight of ion exchanged water) in the final mixed solution. The critical micell concentration of SR-10 is 0.7 g/liter. Furthermore, 220 ml of ion exchanged water was added and mixed with stirring for 1 hour. The mixture obtained was charged into a reaction vessel provided with a reflux tube, a nitrogen inlet tube, a dropping tube, a stirring device and a temperature regulator, the temperature was elevated to 80° C. over 40 minutes while flowing nitrogen, 0.24 g of potassium persulfate dissolved in 100 ml of ion exchanged water was added dropwise over 1 hour, the reaction was further allowed to proceed for 4 hours, and the temperature was then lowered to stop the reaction.

After the completion of polymerization, the pH was adjusted to 8 with an aqueous 1 mol/liter potassium hydroxide solution, and coarse particles were removed through a prefilter. The residue was ultrafiltered by a cross-flow process in an ultrafiltration apparatus and through a concentrating operation, the objective Encapsulated Material Liquid Dispersion M7 having a pigment concentration of 10 wt % was obtained.

### <Production of Encapsulated Material Liquid Dispersion M8>

Dimethylaminoethyl methacrylate methylchloride salt (0.62 g) was added to 136 g of Cyan Pigment P2 (in the form of a liquid dispersion) and mixed with stirring for 30 minutes, and the mixture was then irradiated with an ultrasonic wave for 30 minutes. A mixture obtained by mixing 4.57 g of benzyl methacrylate, 2.55 g of isobornyl methacrylate, 1.35 g of lauryl methacrylate and 5 g of isostearyl alcohol was added thereto and mixed with stirring, and 0.38 g of Anionic Polymerizable Surfactant SR-10 (produced by Asahi Denka Co., Ltd.) dissolved in 100 ml of ion exchanged water was further added to the mixture above and mixed with stirring for 1 hour. Here, the amount of Anionic Polymerizable Surfactant SR-10 (produced by Asahi Denka Co., Ltd.) added was adjusted such that the concentration of SR-10 in the final mixed solution (mixed solution immediately before the addition of a polymerization initiator) became the critical micell concentration of SR-10 for the water amount (weight of ion exchanged water) in the final mixed solution. The critical micell concentration of SR-10 is 0.7 g/liter. Furthermore, 220 ml of ion exchanged water was added and mixed with stirring for 1 hour. The mixture obtained was charged into a reaction vessel provided with a reflux tube, a nitrogen inlet tube, a dropping tube, a stirring device and a temperature regulator, the temperature was elevated to 80° C. over 40 minutes while flowing nitrogen, 0.24 g of potassium persulfate dissolved in 100 ml of ion exchanged water was added dropwise over 1 hour, the reaction was further allowed to proceed for 4 hours, and the temperature was then lowered to stop the reaction.

After the completion of polymerization, the pH was adjusted to 8 with an aqueous 1 mol/liter potassium hydroxide solution, and coarse particles were removed through a prefilter. The residue was ultrafiltered by a cross-flow process in an ultrafiltration apparatus and through a concentrating operation, the objective Encapsulated Material Liquid Dispersion M8 having a pigment concentration of 10 wt % was obtained.

### <Production of Encapsulated Material Liquid Dispersion H1>

Dimethylaminoethyl methacrylate methylchloride salt (2.41 g) was added to an aqueous liquid dispersion obtained by dispersing 100 g of Magenta Pigment P1 in 900 g of ion exchanged water and mixed with stirring for 30 minutes, and the mixture was then irradiated with an ultrasonic wave for 30 minutes. A mixture obtained by mixing 97.5 g of benzyl methacrylate, 37.5 g of isobornyl methacrylate and 15.0 g of lauryl methacrylate was added thereto and mixed with stirring, and 9.79 g of Anionic Polymerizable Surfactant SR-10 (produced by Asahi Denka Co., Ltd.) dissolved in 100 ml of ion exchanged water was further added to the mixture above and mixed with stirring for 1 hour. Here, the amount of Anionic Polymerizable Surfactant SR-10 (produced by Asahi Denka Co., Ltd.) added was adjusted to become equimolar to the amount of dimethylaminoethyl methacrylate methylchloride salt added. Furthermore, 393 ml of ion exchanged water was added and mixed with stirring for 1 hour. The mixture obtained was charged into a reaction vessel provided with a reflux tube, a nitrogen inlet tube, a dropping tube, a stirring device and a temperature regulator, the temperature was elevated to 80° C. over 40 minutes while flowing nitrogen, 3.0 g of potassium persulfate dissolved in 600 ml of ion exchanged water was added dropwise over 1 hour, the reaction was further allowed to proceed for 4 hours, and the temperature was then lowered to stop the reaction.

After the completion of polymerization, the pH was adjusted to 8 with an aqueous 1 mol/liter potassium hydroxide solution, and coarse particles were removed through a prefilter. The residue was ultrafiltered by a cross-flow process in an ultrafiltration apparatus to obtain the objective Encapsulated Material Liquid Dispersion H1. Incidentally, the glass transition temperature of the coat polymer was set to 58° C. by using the Fox formula.

### <Production of Encapsulated Material Liquid Dispersion H2>

Dimethylaminoethyl methacrylate methylchloride salt (0.62 g) was added to 136 g of Cyan Pigment P2 (in the form of a liquid dispersion) and mixed with stirring for 30 minutes, and the mixture was then irradiated with an ultrasonic wave for 30 minutes. A mixture obtained by mixing 4.57 g of benzyl methacrylate, 2.55 g of isobornyl methacrylate and 1.35 g of lauryl methacrylate was added thereto and mixed with stirring, and 1.98 g of Anionic Polymerizable Surfactant SR-10 (produced by Asahi Denka Co., Ltd.) dissolved in 100 ml of ion exchanged water was further added to the mixture above and mixed with stirring for 1 hour. Here, the amount of Anionic Polymerizable Surfactant SR-10 (produced by Asahi Denka Co., Ltd.) added was adjusted to become equimolar to the amount of dimethylaminoethyl methacrylate methylchloride salt added. Furthermore, 430 ml of ion exchanged water was added and mixed with stirring for 1 hour. The mixture obtained was charged into a reaction vessel provided with a reflux tube, a nitrogen inlet tube, a dropping tube, a stirring device and a temperature regulator, the temperature was elevated to 80° C. over 40 minutes while flowing nitrogen, 0.45 g of potassium persulfate dissolved in 100 ml of ion exchanged water was added dropwise over 1 hour, the reaction was further allowed to proceed for 4 hours, and the temperature was then lowered to stop the reaction.

After the completion of polymerization, the pH was adjusted to 8 with an aqueous 1 mol/liter potassium hydroxide solution, and coarse particles were removed through a prefilter. The residue was ultrafiltered by a cross-flow process in an ultrafiltration apparatus and through a concentrating operation, the objective Encapsulated Material Liquid Dispersion H2 having a pigment concentration of 10 wt % was obtained. Incidentally, the glass transition temperature of the coat polymer was set to 52° C. by using the Fox formula.

### (Evaluation 1)

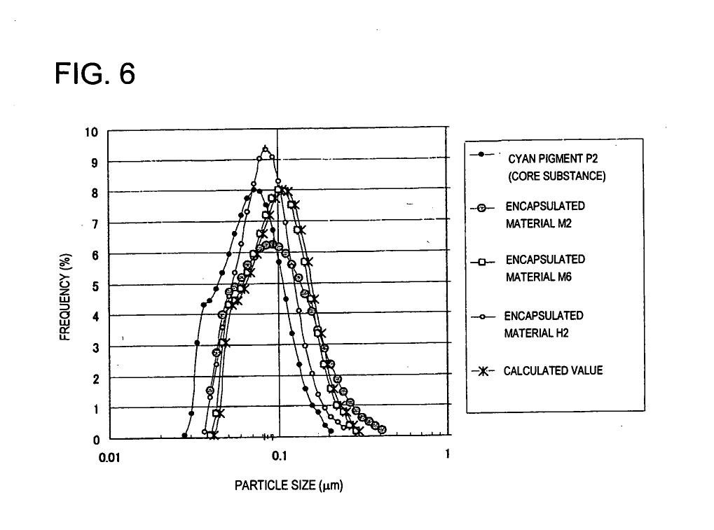

With respect to a liquid dispersion in which Magenta Pigment P1 having an anionic group on its surface was dispersed in ion exchanged water, a liquid dispersion of Cyan Pigment P2 having adsorbed to the surface thereof an anionic polymerizable surfactant, and Encapsulated Material Liquid Dispersions M1 to M8, H1 and H2 obtained above, the particle size distribution of the dispersoid (pigment particle or encapsulated material) in each liquid dispersion was measured using a laser Doppler system particle size distribution analyzer, Microtrac UPA150, manufactured by Leads & Northlop Co., and the peak particle size and volume average particle size were determined from the particle size distribution obtained. The volume average particle sizes of the liquid dispersions using Magenta Pigment P1 as the raw material (core substance) are shown in Table 1 below, and the peak particle sizes of liquid dispersions using Cyan Pigment P2 are shown in Table 2 below. Also, FIG. 6 shows the particle size distribution with respect to Cyan Pigment P2 (core substance) and Encapsulated Material M2, M6 and H2 and the calculated value (expected value) of particle size distribution calculated from the charged amount and the like of the raw material.

TABLE 1

| | | | Addition of | |
|---|---|---|---|---|
| | Encapsulated | | Higher Alcohol | Volume |
| | Material | Core | Having Carbon | Average |
| | Liquid | Substance | Number of 6 or | Particle |
| | Dispersion | (pigment) | More | Size (nm) |
| Raw material | — | P1 | — | 95 |
| Example 1 | M1 | P1 | none | 162 |
| Comparative | H1 | P1 | none | 110 |
| Example 1 | | | | |

TABLE 2

| | | | Addition of | |
|---|---|---|---|---|
| | Encapsulated | | Higher Alcohol | |
| | Material | Core | Having Carbon | Peak |
| | Liquid | Substance | Number of 6 or | Particle |
| | Dispersion | (pigment) | More | Size (nm) |
| Raw material | — | P2 | — | 72 |
| Example 2 | M2 | P2 | none | 91 |
| Example 3 | M3 | P2 | none | 98 |
| Example 4 | M4 | P2 | none | 106 |
| Example 5 | M5 | P2 | none | 118 |
| Example 6 | M6 | P2 | added | 102 |
| Example 7 | M7 | P2 | added | 100 |
| Example 8 | M8 | P2 | added | 120 |
| Comparative | H2 | P2 | none | 81 |
| Example 2 | | | | |

In Example 1 and Comparative Example 1, the amount of the hydrophobic monomer to the reaction system, which is a factor substantially determining the wall material thickness, is the same, nevertheless, as shown in Table 1, the volume average particle size of the encapsulated material obtained is larger in Example 1. Example 1 and Comparative Example 1 differ in the amount of the ionic polymerizable surfactant B (SR-10) added and in Example 1, the amount of the ionic polymerizable surfactant B added is made to agree with the critical micell concentration of the ionic polymerizable surfactant B for the water amount in the final mixed solution (reaction solution immediately before the addition of a polymerization initiator), whereas in Comparative Example 1, the amount of the ionic polymerizable surfactant B added is adjusted to become equimolar to the amount of the ionic monomer added (the added amount equimolar to the amount of the ionic monomer added is an amount different from the critical micell concentration of the ionic polymerizable surfactant B for the water amount in the final mixed solution immediately before the addition of a polymerization initiator). Incidentally, the amount of the ionic polymerizable surfactant B added is by far smaller as compared with the amount of the hydrophobic monomer added and therefore, the difference in the amount of the ionic polymerizable surfactant B between Example 1 and Comparative Example 1 has substantially no effect on the particle size of the encapsulated material.

This relationship between Example 1 and Comparative Example 1 applies directly to the relationship between Example 2 and Comparative Example 2 (see, Table 2).

From these, it is seen that when the amount of the ionic polymerizable surfactant B added to the reaction system is made to agree with the above-described critical micell concentration of the ionic polymerizable surfactant B as in the present invention, this is effective in increasing the particle size (thickness of the wall material) of the encapsulated material.

Also, in Examples 2 to 5, the amount of the hydrophobic monomer added was increased in the order of Example 2, Example 3, Example 4 and Example 5 (in Example 5, the amount of the hydrophobic monomer added was largest), as a result, as shown in Table 2, the peak particle size of the encapsulated material obtained was increased in this order. It is seen that according to the production method of the present invention, an encapsulated material having a particle size proportional to the amount of the hydrophobic monomer added to the reaction system can be obtained and the particle size can be easily controlled.

Example 2 differs from Examples 6 to 8 only in that a higher alcohol having a carbon number of 6 or more is added or not added. As shown in Table 2, in Examples 6 to 8 where the encapsulated material was produced by adding the higher alcohol to the reaction system, the peak particle size of the encapsulated material obtained is large as compared with Example 2 where the encapsulated material was produced without adding the higher alcohol.

Furthermore, as shown in FIG. 6, when the particle size distribution is compared between Example 2 (Encapsulated Material M2) and Example 6 (Encapsulated Material M6), Encapsulated Material M6 exhibits a particle size distribution nearly as calculated, and the particle size distribution has a narrow and sharp width as compared with Encapsulated Material M2.

It is seen from these that the addition of a higher alcohol having a carbon number of 6 or more to the reaction system is effective in increasing the particle size (increasing the thickness of wall material) and making sharp the width of particle size distribution of the encapsulated material (making uniform the particle size).

### (Evaluation 2)

Ink 1, Ink 2, Ink 3, Ink 4 and Comparative Ink 1 were prepared according to the following procedure by using Encapsulated Material Liquid Dispersion M2, Encapsulated Material Liquid Dispersion M6, Encapsulated Material Liquid Dispersion M7, Encapsulated Material Liquid Dispersion M8 and Encapsulated Material Liquid Dispersion H2, respectively. With respect to the inks obtained, the scratch resistance and gloss of the printed image were evaluated by the following methods. The evaluation results are shown in Table 3 below.

### <Ink 1>

Glycerin (15 g), 5 g of triethylene glycol monobutyl ether, 2 g of 1,2-hexanediol, 5 g of trimethylolpropane, 1 g of 2-pyrrolidone, 1 g of OLFINE E1010, 0.05 g of PROXEL XL-2 and 30.95 g of ion exchanged water were mixed, and 1 g of potassium hydroxide in a concentration of 10 wt % was further added thereto and mixed to obtain a liquid mixture. This liquid mixture was added to 40 g of Encapsulated Material Liquid Dispersion M2, and the encapsulated material was dispersed using a stirring device to obtain the objective Ink 1.

### <Ink 2>

Glycerin (15 g), 5 g of triethylene glycol monobutyl ether, 2 g of 1,2-hexanediol, 5 g of trimethylolpropane, 1 g of 2-pyrrolidone, 1 g of OLFINE E1010, 0.05 g of PROXEL XL-2 and 30.95 g of ion exchanged water were mixed, and 1 g of potassium hydroxide in a concentration of 10 wt % was further added thereto and mixed to obtain a liquid mixture. This liquid mixture was added to 40 g of Encapsulated Material Liquid Dispersion M6, and the encapsulated material was dispersed using a stirring device to obtain the objective Ink 2.

### <Ink 3>

Glycerin (15 g), 5 g of triethylene glycol monobutyl ether, 2 g of 1,2-hexanediol, 5 g of trimethylolpropane, 1 g of 2-pyrrolidone, 1 g of OLFINE E1010, 0.05 g of PROXEL XL-2 and 30.95 g of ion exchanged water were mixed, and 1 g of potassium hydroxide in a concentration of 10 wt % was further added thereto and mixed to obtain a liquid mixture. This liquid mixture was added to 40 g of Encapsulated Material Liquid Dispersion M7, and the encapsulated material was dispersed using a stirring device to obtain the objective Ink 3.

### <Ink 4>

Glycerin (15 g), 5 g of triethylene glycol monobutyl ether, 2 g of 1,2-hexanediol, 5 g of trimethylolpropane, 1 g of 2-pyrrolidone, 1 g of OLFINE E1010, 0.05 g of PROXEL XL-2 and 30.95 g of ion exchanged water were mixed, and 1 g of potassium hydroxide in a concentration of 10 wt % was further added thereto and mixed to obtain a liquid mixture. This liquid mixture was added to 40 g of Encapsulated Material Liquid Dispersion M8, and the encapsulated material was dispersed using a stirring device to obtain the objective Ink 4.

### <Comparative Ink 1>

Glycerin (15 g), 5 g of triethylene glycol monobutyl ether, 2 g of 1,2-hexanediol, 5 g of trimethylolpropane, 1 g of 2-pyrrolidone, 1 g of OLFINE E1010, 0.05 g of PROXEL XL-2 and 30.95 g of ion exchanged water were mixed, and 1 g of potassium hydroxide in a concentration of 10 wt % was further added thereto and mixed to obtain a liquid mixture. This liquid mixture was added to 40 g of Encapsulated Material Liquid Dispersion H2, and the encapsulated material was dispersed using a stirring device to obtain the objective Comparative Ink 1.

### <Ejection Stability>

Inks 1 to 4 and Comparative Ink 1 prepared above each was filled in an ink cartridge, the ink cartridge was loaded on Inkjet Printer PX-600C (product name, manufactured by Seiko Epson Corp.), and a solid image (100% duty) was printed on 500 sheets of photopaper <KOTAKU> (trade name, produced by Seiko Epson Corp.) at 1,440×720 dpi, as a result, the inks all exhibited excellent ejection stability without causing an ejection failure.

### <Evaluation of Scratch Resistance of Printed Image>

Inks 1 to 4 and Comparative Ink 1 prepared above each was filled in an ink cartridge, the ink cartridge was loaded on Inkjet Printer PX-600C (product name, manufactured by Seiko Epson Corp.), solid printing at 100% duty was performed in the region of 10 mm×10 mm on Superfine Special Gloss Film (trade name, produced by Seiko Epson Corp.), and the printed matter was left standing at a temperature of 25° C. for 1 hour. Thereafter, the printed region was rubbed with an aqueous yellow fluorescent marker pen, ZEBRA PEN 2 (trademark), (trade name, produced by ZEBRA) under a load of 500 g on the pen tip at a speed of 10 mm/sec, and whether staining was generated in the printed region was observed. The observation results were evaluated according to the following criteria. Rating A is highest rating.

### [Evaluation Criteria]

A: Staining is not generated at all in the printed region even by rubbing three or more times.

B: Staining is not generated at all in the printed region even by rubbing twice.

C: Staining is generated in the printed region by rubbing only once.

### <Evaluation of Gloss of Printed Image>

Inks 1 to 4 and Comparative Ink 1 prepared above each was filled in an ink cartridge, the ink cartridge was loaded on Inkjet Printer EM-930C (trade name, manufactured by Seiko Epson Corp.), and a solid image (100% duty) was printed on photopaper <KOTAKU> (trade name, produced by Seiko Epson Corp.) at 1,440×720 dpi.

An automatic goniophotometer, GP-200 (manufactured by Murakami Color Research Laboratory Co., Ltd.) was used as the measuring apparatus, and the specular gloss on the recording surface at an incident angle 45° was measured under the conditions of 12 V, 50 W, an incident light beam aperture diameter of 1 mm, a reflected light aperture diameter of 1.5 mm, an ND10 filter, an angle of incidence of 45°, a tilting angle of 0° and a 42.5 standard specular plate. The evaluation results were evaluated according to the following criteria. Rating AA is highest rating.

### [Evaluation Criteria]

AA: The gloss value exceeds 40.

A: The gloss value is from more than 30 to 40.

B: The gloss value is from more than 20 to 30.

C: The gloss value is from more than 10 to 20.

D: The gloss value is from 1 to 10.

TABLE 3

| | Scratch Resistance | Gloss |
|---|---|---|
| Ink 1 | B | B |
| Ink 2 | A | AA |
| Ink 3 | A | AA |
| Ink 4 | A | AA |
| Comparative Ink 1 | B | B |

As apparent from the results in Table 3, Inks 2 to 4 using an encapsulated material produced with use of a higher alcohol having a carbon number of 6 or more are excellent in the scratch resistance and gloss as compared with Ink 1 and Comparative Ink 1 produced without use of the higher alcohol. Also, as described above, Inks 2 to 4 are excellent in the ejection stability similarly to Ink 1 and Comparative Ink 1. In general, the scratch resistance and gloss of the printed image are better as the ink color material (encapsulated material) has higher film-forming property on the recording paper, and the ejection stability of the ink is better as the ink color material (encapsulated material) has higher dispersion stability in the aqueous medium.

It is seen from these that the addition of a higher alcohol having a carbon number of 6 or more is effective for enhancement of the film-forming property of the encapsulated material and enhancement of the dispersion stability of the encapsulated material in the aqueous medium.

While the present invention has been described in detail and with reference to specific embodiments thereof, it will be apparent to one skilled in the art that various changes and modifications can be made therein without departing from the spirit and scope thereof.

This application is based on Japanese Patent Application No. 2007-013442 filed on Jan. 24, 2007, and the contents thereof are herein incorporated by reference.

What is claimed is:

1. A method for producing an encapsulated material in which a core substance having an electric charge on its surface is coated with a wall material mainly comprising a polymer, the production method comprising (1) the following steps 1, 2a, 3a and 4a or (2) the following steps 1, 2b, 3b and 4b:
step 1: a step of adding and mixing an ionic polymerizable surfactant A and/or ionic monomer containing an ionic group with an electric charge opposite the electric charge on the surface of said core substance, a hydrophobic group and a polymerizable group to an aqueous solvent containing said core substance, thereby adsorbing said ionic polymerizable surfactant A and/or ionic monomer to the surface of said core substance;
step 2a: a step of adding and mixing a hydrophobic monomer to the mixed solution passed through the step 1 above;
step 3a: a step of adding and mixing an ionic polymerizable surfactant B containing an ionic group with an electric charge the same as or opposite the electric charge on the surface of said core substance, a hydrophobic group and a polymerizable group to the mixed solution passed through the step 2a above, such that the concentration of said ionic polymerizable surfactant B in a mixed solution finally obtained in the step 3a becomes the critical micell concentration of said ionic polymerizable surfactant B for the water amount in said final mixed solution;
step 4a: a step of adding and mixing a polymerization initiator to the mixed solution passed through the step 3a above to polymerize said ionic polymerizable surfactant A and/or ionic monomer, said hydrophobic monomer and said ionic polymerizable surfactant B and thereby form said polymer;
step 2b: a step of adding and mixing an ionic polymerizable surfactant B containing an ionic group with an electric charge the same as or opposite the electric charge on the surface of said core substance, a hydrophobic group and a polymerizable group to the mixed solution passed through the step 1 above, such that the concentration of said ionic polymerizable surfactant B in a mixed solution finally obtained in the step 3b becomes the critical micell concentration of said ionic polymerizable surfactant B for the water amount in said final mixed solution;
step 3b: a step of adding and mixing a hydrophobic monomer to the mixed solution passed through the step 2b above;
step 4b: a step of adding and mixing a polymerization initiator to the mixed solution passed through the step 3b above to polymerize said ionic polymerizable surfactant A and/or ionic monomer, said ionic polymerizable surfactant B and said hydrophobic monomer and thereby form said polymer.

2. The method for producing an encapsulated material as claimed in claim 1, wherein in said step 2a or 3b, a higher alcohol having a carbon number of 6 or more is further added and mixed to said mixed solution.

3. The method for producing an encapsulated material as claimed in claim 1, wherein in said step 3a or 2b, a nonionic polymerizable surfactant containing a nonionic group, a hydrophobic group and a polymerizable group is further added and mixed to said mixed solution such that the concentration of said nonionic polymerizable surfactant in said final mixed solution becomes the critical micell concentration of said nonionic polymerizable surfactant for the water amount in said final mixed solution.

4. The method for producing an encapsulated material as claimed in claim 1, wherein in said step 1, after said ionic polymerizable surfactant A and/or ionic monomer is added and mixed to an aqueous solvent containing said core substance, an ultrasonic wave is irradiated on said aqueous solvent.

5. The method for producing an encapsulated material as claimed in claim 1, wherein said core substance is a color material.

6. An encapsulated material produced by the production method claimed in claim 1.
